(19) United States
(12) Patent Application Publication
(10) Pub. No.: US 2013/0081080 A1
(43) Pub. Date: Mar. 28, 2013

(54) TELEVISION RECEIVER

(71) Applicant: Takakazu Shiomi, Osaka (JP)

(72) Inventor: Takakazu Shiomi, Osaka (JP)

(73) Assignee: PANASONIC CORPORATION, Osaka (JP)

(21) Appl. No.: 13/643,523

(22) PCT Filed: Mar. 23, 2011
(86) PCT No.: PCT/JP2011/001691

§ 371 Date: Dec. 5, 2012

(30) Foreign Application Priority Data
Jul. 9, 2010 (JP) 2010-156887

(51) Int. Cl. H04N 21/45

(52) U.S. Cl. CPC H04N 21/4516
USPC 725/37

(57) ABSTRACT

A television receiver that allows an application to flexibly present a message regardless of a state of the television receiver, the television receiver including: an application engine that executes a first application program and a second application program; an application registration API that receives activation program information and an activation time from the executed first application program, and registers the activation program information and the activation time; and an application timer that activates the application engine at the registered activation time, wherein the application engine executes the second application program indicated by the registered activation program information, and presents a message specified by the execution of the second application program.

### TECHNICAL FIELD

The present invention relates to television receivers, and more specifically to a television receiver that enables a downloaded application to control a message display function via an application program interface (API).

### BACKGROUND ART

Nowadays television receivers have a function to display a specific message according to a time or the like (see Patent Literature (PTL) 1, for instance).

FIG. 32 is a block diagram showing a configuration of a message display device disclosed by PTL 1. A command input circuit 3201 includes a remote control, a front panel, and so on, and accepts a key input from a user. A CPU 3202 obtains via the command input circuit 3201 a “message to be displayed” or a “date and time for displaying the message that are desired” by the user, and stores the message or the date and time into a memory 3203. In addition, the CPU 3202 periodically refers to a clock 3204, and checks whether or a date and time indicated by the clock 3204 matches the “date and time for displaying the message that are desired” stored in the memory 3203. When the date and time matches the “date and time of displaying the message that are desired,” the CPU 3202 displays, on a monitor 3205, the “message to be displayed” stored in the memory 3203. In the message display device disclosed by PTL 1, however, messages to be displayed and dates and times for displaying the messages are limited to those inputted by key operations of the user. Moreover, the user has to spend time and effort on key operations.

On the other hand, the existing television receivers have a function to download and execute an application program (hereafter, referred to as an application). An example of the function is specified in the European Digital TV Standards DVB-MHP (ETSI TS 101 812 V1. 3. 1). A television receiver compliant with the DVB-MHP standards downloads and executes a Java (registered trademark) application. In addition, the television receiver compliant with the DVB-MHP standards includes a Java (registered trademark) API for obtaining program information encoded in broadcast waves. Consequently, the download Java (registered trademark) application obtains the program information via the Java (registered trademark) API, and performs an electronic program guide (EPG) function. Alternatively, the Java (registered trademark) application executes a game application using a graphics function, or displays various messages. In other words, the television receiver compliant with the DVB-MHP standards executes an application, and displays a message specified by the application on a date and time specified by the same. Thus, as with the message display device disclosed by PTL 1, the television receiver compliant with the DVB-MHP standards requires no key operation of the user, and saves the user the time and effort.

### CITATION LIST

### Patent Literature

### [PTL 1]

Japanese Unexamined Patent Application Publication No. 06-028138

### SUMMARY OF INVENTION

### Technical Problem

However, the television receiver compliant with the DVB-MHP standards can display messages only when the television receiver is in a limited state.

Specifically, the execution of the Java (registered trademark) application by the television receiver compliant with the DVB-MHP standards is limited to only when a video of a channel that permits the execution of the Java (registered trademark) application is being displayed. When the television receiver compliant with the DVB-MHP standards is performing, for example, an image viewer function to display a setting screen for a built-in terminal or an image stored in an SD memory card, the television receiver compliant with the DVB-MHP standards does not execute the Java (registered trademark) application. Here, when the Java (registered trademark) application is not being executed by performing the image viewer function or the like on a date and time specified by the Java (registered trademark) application, a message is not displayed by the Java (registered trademark) application. To put it differently, display of a message by a downloaded Java (registered trademark) application is limited to a state where the Java (registered trademark) application is being executed on a date and time specified by the Java (registered trademark) application.

The present invention has been conceived to solve the above problem, and an object of the present invention is to provide a television receiver that enables an application to flexibly present a message regardless of a state of the television receiver.

### Solution to Problem

In order to achieve the object, a television receiver according to an aspect of the present invention is a television receiver that presents a message, the television receiver including: a receiving unit that receives broadcast waves; a reproduction unit that reproduces video and audio from the broadcast waves received by the receiving unit; a video display unit that displays the video reproduced by the reproduction unit; an audio output unit that outputs the audio reproduced by the reproduction unit; an application execution unit that reads and executes a first application program; an application information registration unit that receives activation program information and an activation time from the first application program executed by the application execution unit, and registers the activation program information and the activation time; and an activation control unit that activates the application execution unit at the activation time registered by the application information registration unit, wherein in response to an activation instruction from the activation control unit, the application execution unit executes a second application program that presents the message and is indicated by the activation program information registered by the application information registration unit. For instance, the first and second application programs are the same health management application program.

With this configuration, the execution of the first application program leads to the registration of the activation program information and the activation time, and the activation control unit activates the application execution unit at the activation time. Thus, even when the application execution unit is not activated, that is, the second application program is not executed, it is possible to activate the application execution unit at the activation time to execute the second application program indicated by the registered activation program information. As a result, in the case where the second application program is scheduled to make it possible to present a message at the activation time, as long as the first application program registers in advance the activation time and the activation program information indicating the second application program, the second application program makes it possible to present the message at the activation time regardless of a state of the television receiver at the activation time. Furthermore, the message is not set by the user or preset but is specified by the second application program, and thus it is possible to increase a degree of flexibility in display contents and a display state of the message.

Moreover, the application information registration unit includes: an accepting unit that accepts the activation program information and the activation time; a registration unit that assigns application identification information to the accepted activation program information and activation time, and registers a set including the application identification information, the activation program information, and the activation time, in application registration information; and a sending unit that sends, to the first application program, the application identification information assigned to the activation program information and the activation time.

With this configuration, the application identification information assigned to the activation program information and the activation time is sent to the first application program. Consequently, even when plural activation program information and activation times are registered, the first application program makes it possible to specify, using application identification information, registered activation program information and activation time that are desired, and use the desired registered activation program information and activation time, thereby increasing a degree of flexibility in processing performed by the first application program.

Moreover, the application information registration unit provides an application program interface (API) to the first application program, and the accepting unit accepts the activation program information and the activation time from the first application program via the API, and the sending unit sends the application identification information assigned by the registration unit, to the first application program.

With this configuration, the API is provide to the first application program even when the first application program has no function to register activation program information and an activation time in the television receiver, and thus the first application program makes it possible to specify activation program information and an activation time that are to be registered, register the activation program information and the activation time in the television receiver via the API, and receive the application identification information via the API.

Moreover, a plurality of sets each including application identification information, activation program information, and an activation time are registered in the application registration information, and when activated by the activation control unit, the application execution unit determines, among the sets registered in the application registration information, a set including the activation time corresponding to a current time, and executes the second application program indicated by the activation program information included in the determined set.

With this configuration, even when the sets are registered in the application registration information, each of the sets includes the activation time, and thus every time activated, the application execution unit makes it possible to select and execute an appropriate second application program corresponding to a time at which the activation is performed.

Moreover, the television receiver further includes: an application identification information accepting unit that accepts application identification information from the first application program executed by the application execution unit; and a deleting unit that deletes, from the application registration information, a set including application identification information identical to the application identification information accepted by the application identification information accepting unit.

With this configuration, the set corresponding to the application identification information accepted from the first application program is deleted from the application registration information, and thus the first application program makes it possible to specify and delete a registered set, and prevent a second application program of the specified set from being executed.

Moreover, the television receiver further includes a download unit that downloads at least one of the first and second application programs via a network.

With this configuration, even when the first and second application programs are not stored in the television receiver, the first and second application programs can be downloaded from the outside of the television receiver and executed.

Moreover, the application information registration unit accepts and registers the activation time as a time that has passed since the television receiver was powered on, and the activation control unit activates the application execution unit when the time registered by the application information registration unit has passed since the television receiver was powered on.

With this configuration, the first application program makes it possible to control timing with which the application execution unit is activated, that is, timing with which the message is presented, with reference to a time when the television receiver is powered on.

Moreover, the application information registration unit registers, as the second application program, the activation program information indicating the first application program.

With this configuration, the first application program makes it possible to activate the application execution unit at the activation time and cause the application execution unit to execute the first application program.

Moreover, the television receiver further includes: a message information registration unit that accepts a message and a display start time from the first application program executed by the application execution unit, and registers the message and the display start time; and a message display unit that displays the message registered by the message information registration unit, at the display start time registered by the message information registration unit.

With this configuration, the execution of the first application program leads to the registration of the message and the display start time, and the message is displayed at the display start time. Thus, even when the application execution unit is not activated, that is, the first and second application programs are not executed, it is possible to display the registered message at the display start time. Consequently, in the case where the first application program is scheduled to display the message at the display start time, as long as the first application program registers in advance the message and the display start time, the first application program makes it possible to display the message at the display start time regardless of a state of the television receiver at the display start time.

Moreover, the message information registration unit includes: an accepting unit that accepts the message and the display start time; a registration unit that assigns message identification information to the accepted message and display start time, and registers a set including the message identification information, the message, and the display start time, in the message registration information; and a sending unit that sends the message identification information assigned to the message and the display start time, to the first application program.

With this configuration, the message identification information assigned to the message and the display start time is sent to the first application program, and thus even when messages and display start times are registered, the first application program makes it possible to specify, using the message identification information, a registered message and display start time that are desired, and use the message and the display start time, thereby increasing a degree of flexibility in processing performed by the first application program.

Moreover, the message information registration unit provides an application program interface (API) to the first application program, the accepting unit accepts the message and the display start time from the first application program via the API, and the sending unit sends the message identification information assigned by the registration unit, to the first application program via the API.

With this configuration, the API is provided to the first application program even when the first application program has no function to register a message and a display start time in the television receiver, and thus the first application program makes it possible to specify a message and a display start time that are to be registered, register the message and the display time in the television receiver via the API, and receive the message identification information via the API.

Moreover, a plurality of sets each including message identification information, a message, and a display start time are registered in the message registration information, and the message display unit determines, among the sets registered in the message registration information, a set including the display start time corresponding to a current time, and displays the message included in the determined set.

With this configuration, even when the sets are registered in the message registration information, it is possible to select, for each display start time, an appropriate message corresponding to the display start time and display the message.

Moreover, the television receiver further includes: a message identification information accepting unit that accepts the message identification information from the first application program executed by the application execution unit; and a deleting unit that deletes, from the message registration information, a set including message identification information identical to the message identification information accepted by the message identification information accepting unit.

With this configuration, the set corresponding to the message identification information accepted from the first application program is deleted from the message registration information, and thus the first application program makes it possible to specify and delete a registered set and prevent the message of the specified set from being displayed.

Moreover, the message information registration unit accepts and registers the display start time as a time that has passed since the television receiver was powered on, and the message display unit displays the message registered by the message information registration unit, when the time registered by the message information registration unit has passed since the television receiver was powered on.

With this configuration, the first application program makes it possible to control timing with which the message is displayed, with reference to a time when the television receiver is powered on.

Moreover, the message information registration unit further accepts a display position of the message from the first application program executed by the application execution unit, and registers the display position, and the message display unit displays the message registered by the message information registration unit, at the display position registered by the message information registration unit.

With this configuration, the first application program makes it possible to control the display position of the message.

Moreover, the message information registration unit further accepts a display time period for the message from the first application program executed by the application execution unit, and registers the display time period, and the message display unit displays the message registered by the message information registration unit, for the display time period registered by the message information registration unit.

With this configuration, the first application program makes it possible to control the display time period of the message.

Moreover, the message information registration unit further accepts the message represented as image data from the first application program executed by the application execution unit, and registers the message, and the message display unit displays the message represented as the image data.

With this configuration, the message represented as the image data is displayed, and thus it is possible to display not only a character string but also a combination of character strings and drawings, thereby increasing the expressive power of messages.

It is to be noted that the present invention can be realized not only as such a television receiver but also as a method of processing operations in the television receiver, a program for causing a computer to execute the processing operations, and a storage medium that stores the program.

### Advantageous Effects of Invention

A television receiver according to the present invention enables an application to flexibly present a message regardless of a state of the television receiver.

### BRIEF DESCRIPTION OF DRAWINGS

FIG. 1 is a block diagram showing a configuration of a television according to Embodiment 1 of the present invention.

FIG. 2 is a diagram showing an exemplary appearance of a television according to Embodiment 1 of the present invention.

FIG. 3 is a block diagram showing an exemplary program stored in a first memory according to Embodiment 1 of the present invention.

FIG. 4 is a diagram showing an example of displaying a list of Java (registered trademark) script programs on a monitor according to Embodiment 1 of the present invention.

FIG. 5 is a diagram showing exemplary Java (registered trademark) script program list information stored in the first memory according to Embodiment 1 of the present invention.

FIG. 6 is a diagram showing an exemplary message API according to Embodiment 1 of the present invention.

FIG. 7 is a diagram showing a usage example of time API class Date according to Embodiment 1 of the present invention.

FIG. 8 is a diagram showing exemplary message display information stored in the first memory according to Embodiment 1 of the present invention.

FIG. 9 is a diagram showing an example of displaying a message on the monitor according to Embodiment 1 of the present invention.

FIG. 10 is a block diagram showing a configuration of a health management application according to Embodiment 1 of the present invention.

FIG. 11 is a diagram showing an exemplary screen on which message setting is urged by the health management application according to Embodiment 1 of the present invention.

FIG. 12 is a diagram showing an example of displaying a main screen of the health management application according to Embodiment 1 of the present invention.

FIG. 13 is a diagram showing an exemplary screen on which data transfer is urged by the health management application according to Embodiment 1 of the present invention.

FIG. 14 is a diagram showing an example where the message “data being transferred” is displayed by the health management application according to Embodiment 1 of the present invention.

FIG. 15 is a diagram showing an exemplary management file stored in the first memory according to Embodiment 1 of the present invention.

FIG. 16 is a diagram showing an example where data is displayed by the health management application according to Embodiment 1 of the present invention.

FIG. 17 is a flow chart showing operations of a registration API of a message API according to Embodiment 1 of the present invention.

FIG. 18 is a flow chart showing operations of a deletion API of the message API according to Embodiment 1 of the present invention.

FIG. 19 is a block diagram showing an exemplary program stored in a first memory according to Embodiment 2 of the present invention.

FIG. 20 is a diagram showing exemplary application registration information stored in the first memory according to Embodiment 2 of the present invention.

FIG. 21 is a diagram showing an exemplary application registration API according to Embodiment 2 of the present invention.

FIG. 22 is a block diagram showing a configuration of a health management application according to Embodiment 2 of the present invention.

FIG. 23 is a flow chart showing operations of a registration API of an application registration API according to Embodiment 2 of the present invention.

FIG. 24 is a flow chart showing operations of a deletion API of the application registration API according to Embodiment 2 of the present invention.

FIG. 25 is a diagram showing an exemplary message API according to Embodiment 3 of the present invention.

FIG. 26 is a diagram showing exemplary application display information stored in a first memory according to Embodiment 3 of the present invention.

FIG. 27 is a diagram showing an exemplary message API according to Embodiment 3 of the present invention.

FIG. 28 is a diagram showing an exemplary message API according to Embodiment 3 of the present invention.

FIG. 29 is a diagram showing an exemplary message API according to Embodiment 3 of the present invention.

FIG. 30 is a diagram showing an exemplary screen on which data transfer is urged by a health management application according to Embodiment 4 of the present invention.

FIG. 31 is a diagram showing an example of displaying a message on a monitor according to Embodiment 4 of the present invention.

FIG. 32 is a block diagram showing a configuration of a conventional message display device.

### DESCRIPTION OF EMBODIMENTS

The following describes embodiments of the present invention with reference to the drawings.

### Embodiment 1

A television receiver according to Embodiment 1 of the present invention is described with reference to the drawings. The television receiver according to this embodiment is a television receiver with a message display function.

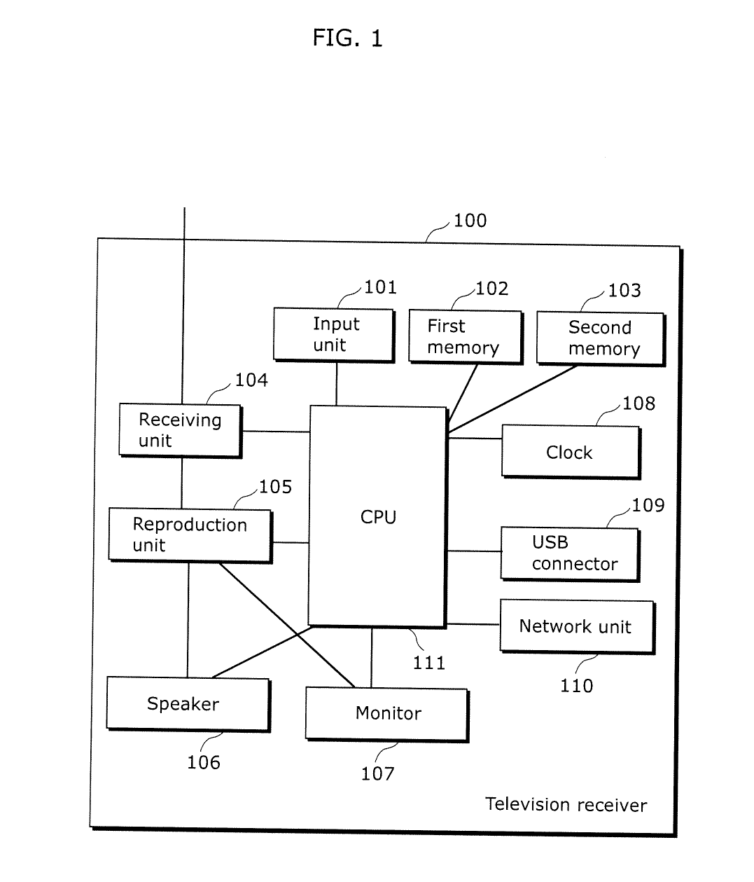

FIG. 1 is a block diagram showing a relationship among constituent elements constituting a television receiver 100 (a television 100). The television receiver 100 includes, as hardware, an input unit 101, a first memory 102, a second memory 103, a receiving unit 104, a reproduction unit 105, a speaker 106, a monitor 107, a clock 108, a USB connector 109, a network unit 110, and a CPU 111.

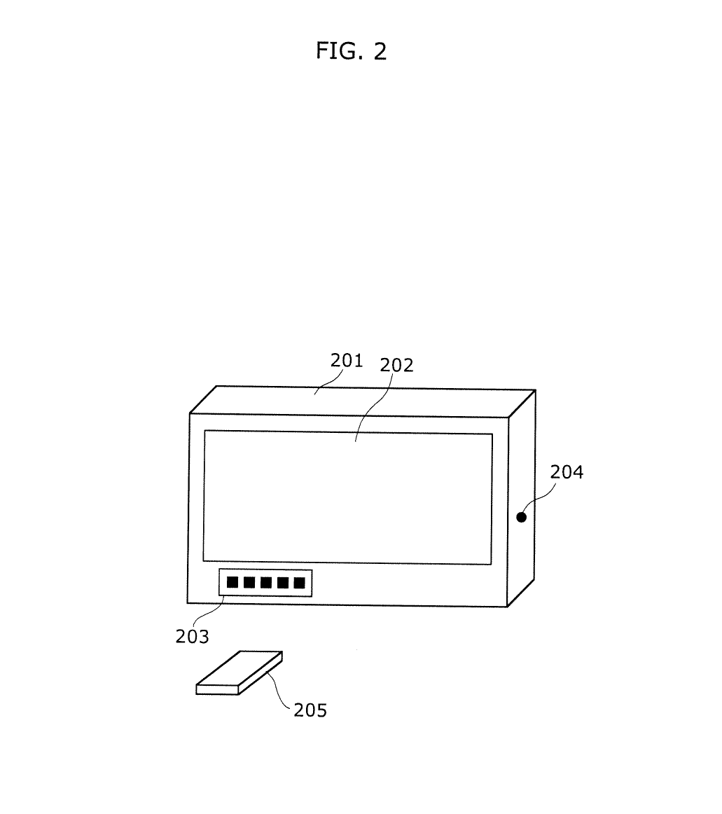

FIG. 2 is a diagram showing an exemplary appearance of the television 100. The television 100 includes a housing 201. Each of the constituent elements shown by FIG. 1 is contained by the housing 201 or attached to the surface of the housing 201. For example, a monitor 202 (corresponding to the monitor 107 in FIG. 1) is contained by the housing 201 so that the monitor 202 is exposed through an opening of the housing 201. The monitor 202 includes, for instance, a cathode ray tube, a plasma display, or a liquid crystal display. A front panel 203 corresponds to the input unit 101 in FIG. 1, and is attached to, for instance, the surface of the housing 201. The television 100 also has an input terminal 204 for connecting the receiving unit 104 to an antenna or a cable from a cable television station. In addition, the television 100 is controlled by a remote control 205. The front panel 203 has, for example, a remote control receiver that receives a remote control signal from the remote control 205. It is to be noted that the remote control receiver may be provided to the television 100 separately from the front panel 203. Moreover, the television 100 needs not include the remote control receiver.

The input unit 101 includes, for instance, the front panel 203 having the remote control receiver as above, and receives channel selection or an information input from a user. The remote control receiver of the input unit 101 receives the channel selection by the user, by receiving an input (a remote control signal) from the remote control 205 shown by FIG. 2.

The first memory 102 is formed as, for instance, a recording medium that holds data even without power supply, such as a flash memory and a hard disk, and stores programs to be executed by the CPU 111. In addition, data or a program specified by the CPU 111 is temporarily stored in or deleted from the first memory 102. The second memory 103 is specifically formed as a RAM or the like. Data or a program specified by the CPU 111 is temporarily stored in or deleted from the second memory 103.

The receiving unit 104 is connected to an antenna or a cable from a cable television station so as to receive broadcast waves, tunes to a frequency specified by the CPU 111, and outputs broadcast waves extracted by the tuning, to the reproduction unit 105.

The reproduction unit 105 obtains the broadcast waves outputted by the receiving unit 104, based on an instruction from the CPU 111, extracts audio and video information from the broadcast waves, and reproduces the audio and video information. The speaker 106 outputs the audio reproduced by the reproduction unit 105. The monitor 107 is formed as a cathode ray tube, a plasma display, a liquid crystal display, or the like, and outputs (displays) the video reproduced by the reproduction unit 105.

The clock 108 keeps time. Stated differently, the clock 108 manages, for example, a current date and time as a current time, and holds time information indicating a current time that is ever-changing. The clock 108 provides the time information to the CPU 111 according to a request from the CPU 111. In addition, the clock 108 modifies the held time information under control of the CPU 111.

The USB connector 109 is a connector compliant with the USB (Universal Serial Bus) standard that is one of serial bus standards for connecting a peripheral device. The CPU 111 controls the USB connector 109 so that information can be exchanged between the CPU 111 and a peripheral device connected to the USB connector 109. The network unit 110 corresponds to a download unit, is specifically formed as an Ethernet (registered trademark) connector or the like, is connected to a network under control of the CPU 111, and communicates with a device connected to the network.

The CPU 111 is a central processing unit that executes the programs stored in the first memory 102.

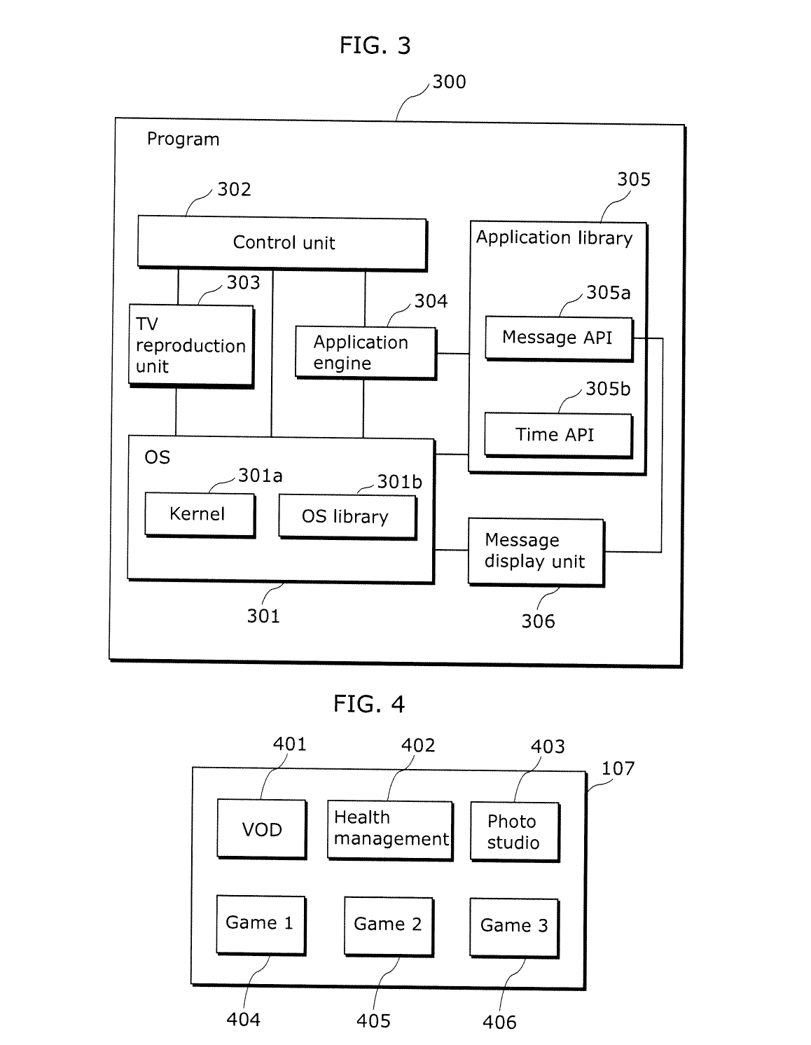

FIG. 3 is a block diagram showing an exemplary configuration of a program stored in the first memory 102 and executed by the CPU 111. A program 300 includes a plurality of subprograms. Specifically, the program 300 includes an OS 301, a control unit 302, a TV reproduction unit 303, an application engine 304, an application library 305, and a message display unit 306.

The OS 301 is a subprogram activated by the CPU 111 when the television 100 is powered on. The term “OS” is an abbreviation for an operating system, and an example of the OS is Linux (registered trademark). The OS 301 is a generic name of a publicly known technique including an OS library 301b and a kernel 301a that executes other subprograms in parallel, and a detailed description thereof is omitted. In this embodiment, the kernel 301a of the OS 301 executes the control unit 302 as a subprogram. The OS library 301b provides a plurality of functions for controlling the constituent elements of the television 100, to the control unit 302, the TV reproduction unit 303, the application engine 304, and subprograms of the application library 305. More specifically, the OS library 301b includes, for instance, a graphics library for performing graphics display of a character, a graphic, or the like to be displayed on the monitor 107, a tuning library for specifying a frequency for tuning to the receiving unit 104 and causing the receiving unit 104 to perform tuning, and a time library having a time information obtaining function for obtaining time information from the clock 108 and a timer function for performing notification at a specific time.

The control unit 302 is a subprogram activated first by the OS 301 when the television 100 is powered on. Upon receiving an instruction from the user, the control unit 302 controls switching of execution of the TV reproduction unit 303 or the application engine 304.

The TV reproduction unit 303 reproduces a TV program. The TV reproduction unit 303 is configured using the existing TV (television) techniques. It is to be noted that since the TV reproduction unit 303 is not a main constituent element of the present invention, functions of the TV reproduction unit 303 are described in brief below. The TV reproduction unit 303 accepts, from the input unit 101, an instruction for a program that the user wants to select (a selection instruction). The TV reproduction unit 303 sends, to the receiving unit 104, an instruction for tuning, according to the accepted selection instruction, and instructs the reproduction unit 105 to reproduce video and audio. The receiving unit 104 performs the tuning according to the instruction. The reproduction unit 105 reproduces a TV program according to the instruction, by outputting video and audio, which are inputted by the receiving unit 104, to the speaker 106 and the monitor 107, respectively.

The application engine 304 executes a downloaded application. In the case where an application is a Java (registered trademark) program, the application engine 304 is a Java (registered trademark) virtual machine (VM), and in the case where an application is a Java (registered trademark) script program, the application engine 304 is a Java (registered trademark) script engine. The following describes an example where the application engine 304 is the Java (registered trademark) script engine.

In this embodiment, when activating the Java (registered trademark) script engine that is the application engine 304, the control unit 302 specifies a Java (registered trademark) script program to be executed. For example, when the user commands, through the input unit 101, the control unit 302 to activate the Java (registered trademark) script program, the control unit 302 uses the graphics function of the OS library 301b to display a list of executable Java (registered trademark) script programs on the monitor 107.

FIG. 4 is a diagram showing an exemplary list of Java (registered trademark) script programs that are displayed on the monitor 107 by the control unit 302. Here, six Java (registered trademark) script programs 401, 402, 403, 404, 405, and 406 are displayed. Information indicating a list of the Java (registered trademark) script programs (list information) may be stored beforehand in the first memory 102, or may be obtained from a specific server (application server) on the Internet via the network unit 110 and then displayed. The user selects, via the input unit 101, a Java (registered trademark) script program to be executed by the control unit 302.

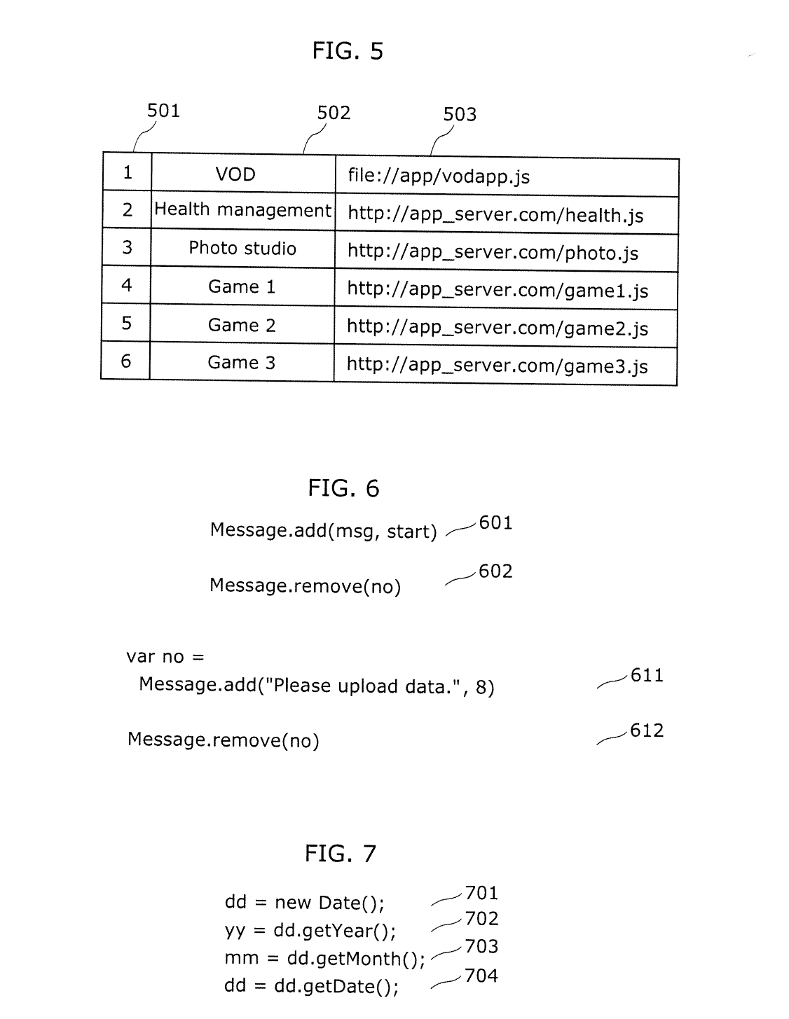

FIG. 5 is a diagram showing an exemplary list of Java (registered trademark) script programs (list information) stored in the first memory 102. Here, information items corresponding to the six Java (registered trademark) script programs 401 to 406 shown by FIG. 4 are stored in the list information. Specifically, the list information has a column 501 that holds an identifier of each of the Java (registered trademark) script programs. The list information has a column 502 that holds a name of each Java (registered trademark) script program, and the names held in the column 502 are displayed on the monitor 107. The list information has a column 503 that holds activation file information (activation program information) items respectively indicating the Java (registered trademark) script programs. For instance, in FIG. 5, an activation file information item of a Java (registered trademark) script program having the identifier “1” indicates that the Java (registered trademark) script program is stored in the first memory 102, and activation file information items of other Java (registered trademark) script programs (the Java (registered trademark) script programs indicated by the respective identifiers “2” to “6”) indicate that the other Java (registered trademark) script programs are on a network.

It is assumed here that the user selects the Java (registered trademark) script program “health management” 402. In this case, the control unit 302 instructs a Java (registered trademark) script engine, the application engine 304, to activate a Java (registered trademark) script program indicated by the activation file information “http://app_server.com/health.js,” by reference to the list information of FIG. 5. The Java (registered trademark) script engine, the application engine 304, downloads, as an application, the Java (registered trademark) script program indicated by the activation file information “http://app_server.com/health.js,” into the second memory 103, using the network unit 110, and executes (activates) the application.

The application library 305 provides, to the downloaded application, various APIs for using functions of the television 100. In the case where the application is a Java (registered trademark) program, the application library 305 is a Java (registered trademark) class library, and in the case where the application is a Java (registered trademark) script program, the application library 305 is a Java (registered trademark) script library.

The application library 305 includes a plurality of libraries. In this embodiment, the application library 305 includes a message API 305a and a time API 305b.

The message API 305a functions to register, from an application, a text to be displayed as a message and a time for displaying the message (a display start time), and to delete a registered message to be displayed.

FIG. 6 is a diagram showing a specific example of the message API 305a. The message API 305a includes the function 601 “Message.add” and the function 602 “Message.remove.” The function 601 “Message.add” is an API that registers a text (message) to be displayed and a time for displaying the message. In the function 601, the first argument “msg” indicates a text to be displayed, and the second argument “start” indicates a time for displaying the message. The function 601 returns a registration number (message identification information) as a return value.

The function 602 “Message.remove” is an API that deletes a registered message to be displayed. A registration number to be returned by the function 601 “Message.add” is assigned to the first argument “no” in the function 602.

Functions 611 and 612 are usage examples of the functions 601 and 602. The function 611 specifies the text to be displayed “Please upload data.” and the time “8” o'clock at which the message is displayed, and stores a registration number, a return value of the function 611, in the variable “no.” In the function 612, the registration number stored in the variable “no” is transferred to arguments of the function 612. The function 612 deletes the message, the text to be displayed that is registered by the function 611.

The message API 305a is capable of registering a plurality of messages. To identify the registered messages, the function 601 “Message.add” returns registration numbers. It is possible to uniquely identify the messages based on the registration numbers. Information registered or deleted by the message API 305a is sent to the message display unit 306.

The time API 305b is an API that obtains a current time. In the Java (registered trademark) script language, “Date” is available as a date object. For details, please refer to the Java (registered trademark) Script Language Specification (ECMA-262 ECM Script Language Specification).

FIG. 7 is a diagram showing a usage example of the time API 305b (time API class date). The time API 305b creates a Date object in a row 701, and obtains a year, a month, and a day in a row 702, a row 703, and a row 704, respectively.

The message display unit 306 manages the information received from the message API 305a, and displays a message on the monitor 107 according to the information. In addition, when managing the information received from the message API 305a, the message display unit 306 generates or updates message display information based on the received information, and stores the generated or updated message display information into the first memory 102.

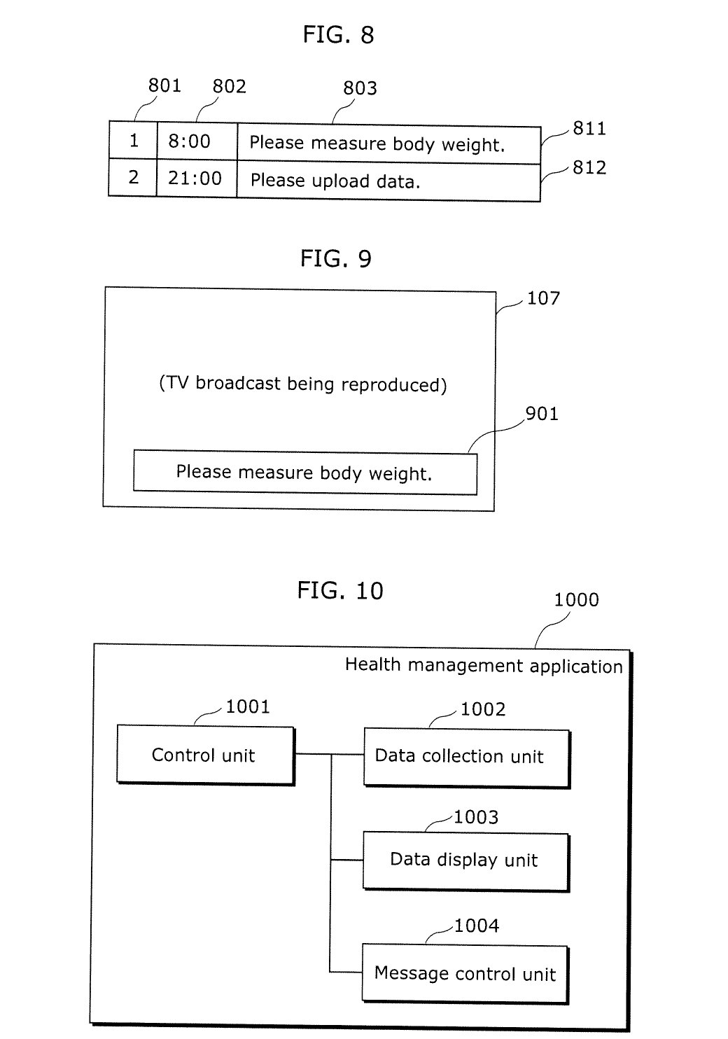

FIG. 8 is a diagram showing exemplary message display information stored in the first memory 102. The message display information has a column 801 in which registration number of a message is registered. The message display information has a column 802 and a column 803 in which a time for displaying the message and the massage to be displayed are registered, respectively. The message display information has a row 811 in which a set including the registration number “1,” the time for displaying a message “8:00,” and the message to be displayed “Please measure body weight.” is registered. Moreover, the message display information has a row 812 in which a set including the registration number “2,” the time for displaying a message “21:00,” and the message to be displayed “Please upload data.” is registered.

The message display unit 306 displays a message on the monitor 107 based on the message display information. The message display unit 306 requests the OS library 301b to call the message display unit 306 at 8:00 and 21:00.

The OS library 301b calls the message display unit 306 at 8:00 and 21:00 by reference to the clock 108. The called message display unit 306 displays, by reference to the message display information stored in the first memory 102, a message corresponding to a time indicated by the clock 108. Specifically, when called at 8:00, the message display unit 306 compares the time indicated by the clock 108 and the time indicated by the message display information stored in the first memory 102, and determines which message is to be displayed. In the case where the message display unit 306 is called at 8:00, the message display unit 306 determines, as the message to be displayed, a message corresponding to the registration number “1” and the time “8:00.” Thus, the message “Please measure body weight.” corresponding to the registration number “1” is displayed.

FIG. 9 is a diagram showing an exemplary state where the message “Please measure body weight.” is displayed on the monitor 107. While a TV program is being reproduced, the message “Please measure body weight.” is displayed in a message window 901 at the lower part of a screen. It is assumed here that a display time period is 3 minutes. The display time period, however, is not limited to 3 minutes, and may be 4 minutes, 5 minutes, or the like.

The following describes a health management application (hereafter, referred to as a health management app) as an example of an application executed by the television 100 with the message display function. The health management app collects data from a pedometer, a body composition meter, a weight scale, and so on (hereafter, collectively referred to as a measurement apparatus), and displays the data. In recent years, pedometers and body composition meters are on sale which hold data accumulated over a past week or so and transfer the data to personal computers via USB cables or the like. Since these measurement apparatuses are incapable of holding a large amount of data due to cost reduction, the measurement apparatuses need to regularly transfer the data to the personal computers or the like and to manage an amount of exercise or weight data. In this embodiment, the health management app in the television 100 collects a measurement value from a measurement apparatus, and performs health management.

FIG. 10 is a block diagram showing a configuration of a health management app. A health management app 1000 includes a control unit 1001 that is a subprogram, a data collection unit 1002, a data display unit 1003, and a message control unit 1004.

The control unit 1001 is a subprogram executed first when the health management app 1000 is activated. When activated, the control unit 1001 initially checks whether or not the health management app 1000 has been executed in the television 100. Specifically, the control unit 1001 checks whether or not a management file of the health management app 1000 is in the first memory 102, using the application library 305. The management file is a file indicating data in a measurement apparatus. In the case where the management file is still not in the first memory 102, the control unit 1001 determines that the health management app 1000 has not been executed in the television 100, and performs management file creation and message initialization.

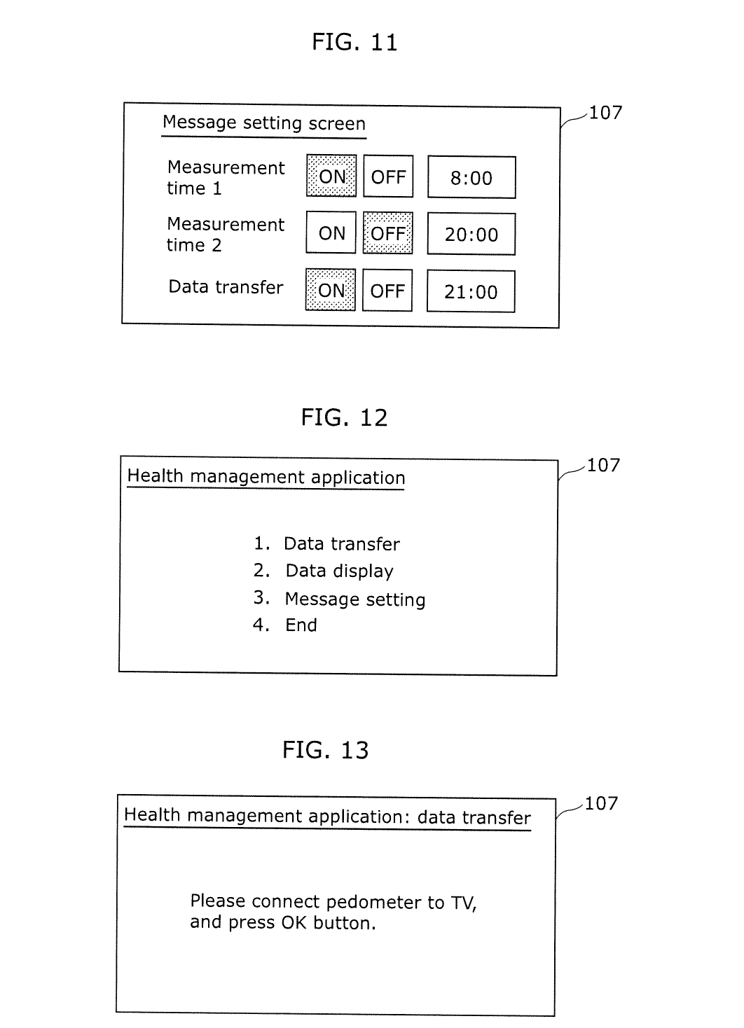

The control unit 1001 requests the data collection unit 1002 to perform the management file creation. The data collection unit 1002 creates a management file having no data in the first memory 102, using the application library 305. The control unit 1001 requests the message control unit 1004 to perform the message initialization. The message control unit 1004 displays a message setting screen as shown by FIG. 11 on the monitor 107 using the application library 305, to urge the user to set a message.

FIG. 11 is a diagram showing an exemplary message setting screen. In the exemplary message setting screen shown by FIG. 11, it is possible to set times (a “measurement time 1” and a “measurement time 2”) each for displaying a message urging daily body weight measurement, and a time for displaying a message urging data transfer. It is also possible to set display or non-display of a message. In FIG. 11, display of a message urging first body weight measurement at a measurement time is set ON, and the measurement time is set to “8:00.” Display of a message urging second body weight measurement at a measurement time is set OFF. Display of a message urging data transfer is set ON, and a display time of the message is set to “21:00.” The user can change the set information through the input unit 101, and determine the settings. When the settings are determined, the message control unit 1004 registers, using the message API 305a provided by the application library 305, a set including a registration number, a time, and a text (message), in message display information, according to the determined information. Specifically, in the case of FIG. 11, the message control unit 1004 sends, to the message display unit 306, times and texts respectively corresponding to two messages, by calling the function 601 “Message.add” two times. The message display unit 306 assigns, for each of the messages, a registration number to the sent time and text, and registers a set including the registration number, the time, and the text, in message display information stored in the first memory 102. FIG. 8 shows the message display information stored in the first memory 102.

FIG. 12 is a diagram showing an exemplary main screen of a health management app. After the above processing, the control unit 1001 displays a main screen as shown by FIG. 12. The user can select a desired process from three options in the main screen. When the user selects “1. Data transfer,” the control unit 1001 requests the data collection unit 1002 to transfer data. When the user selects “2. Data display,” the control unit 1001 requests the data display unit 1003 to display data. When the user selects “3. Message setting,” the control unit 1001 requests the message control unit 1004 to set a message. When the user selects “4. End,” the control unit 1001 ends the health management app 1000.

FIG. 13 is a diagram showing an exemplary data transfer instruction screen for urging a user to transfer data. When the data collection unit 1002 is activated by the control unit 1001 and receives a request for data transfer, the data collection unit 1002 displays a data transfer instruction screen for urging a user to transfer data as shown by FIG. 13. The user connects, for example, a measurement apparatus and the USB connector 109 of the television 100 with a USB cable, and notifies the data collection unit 1002 through the input unit 101 that the data transfer is ready.

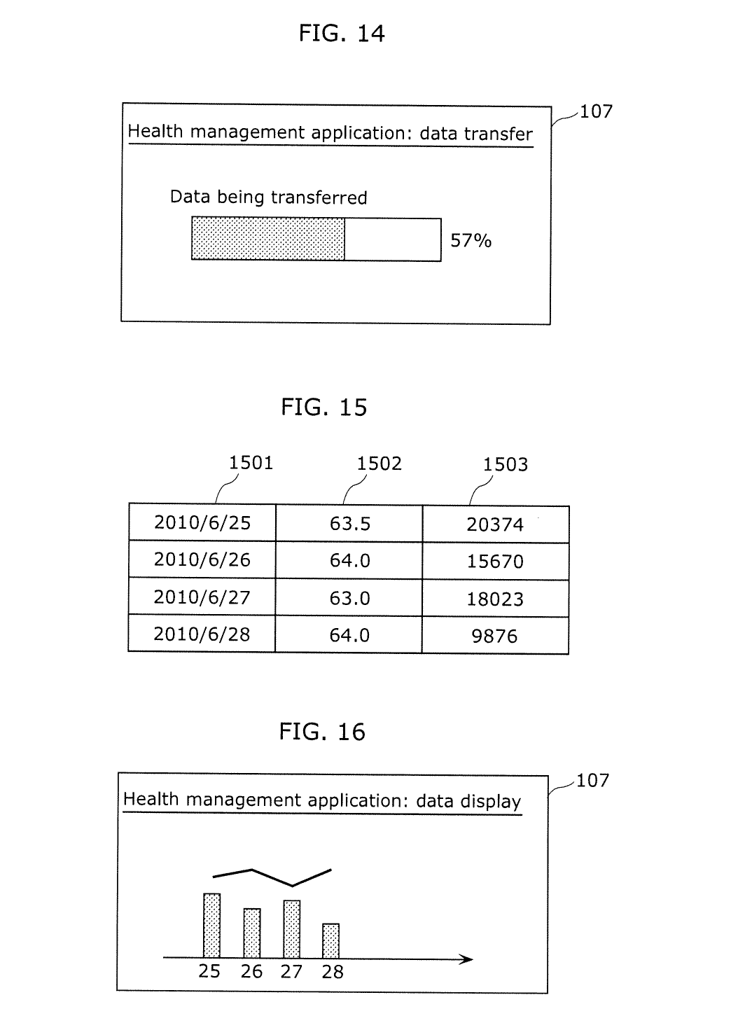

FIG. 14 is a diagram showing an exemplary data transfer state screen showing a data transfer state. When receiving, from the user through the input unit 101 and the application library 305, the notification that the data transfer is ready, as shown by FIG. 14, the data collection unit 1002 displays, on the monitor 107, a data transfer state screen that shows, as a data transfer state, a message indicating data being transferred and a proportion (percentage) of data transferred. The data collection unit 1002 receives measurement data from the measurement apparatus through the USB connector 109, and records the measurement data in a management file in the first memory 102.

FIG. 15 is a diagram showing exemplary contents of a management file. The management file has a column 1501, a column 1502, and a column 1503 in which a date, a body weight, and the number of steps are recorded, respectively. In this example, data items accumulated over four days from June 25 to 28 are recorded.

In the case where the user does not notify the data collection unit 1002 that data transfer is ready after a certain time, such as 10 minutes, has passed since a data transfer instruction screen was displayed, the data collection unit 1002 stops collecting data.

When the data display unit 1003 is activated by the control unit 1001 and receives a request for data display, the data display unit 1003 reads a management file in the first memory 102, and displays, on the monitor 107, contents of the management file as a graph.

FIG. 16 is a diagram showing an exemplary screen on which the contents of the management file shown by FIG. 15 are displayed as a graph. Displaying such a screen as shown by FIG. 16 allows the user to easily understand changes in body weight of the user and step count information.

When the message control unit 1004 is activated by the control unit 1001 and receives a request for message setting, as stated, the message control unit 1004 displays, using the application library 305, the message setting screen as shown by FIG. 11 on the monitor 107, to urge the user to set a message. In the case where the user changes a setting, the message control unit 1004 cancels the current setting using the message API 305a, and registers the changed setting.

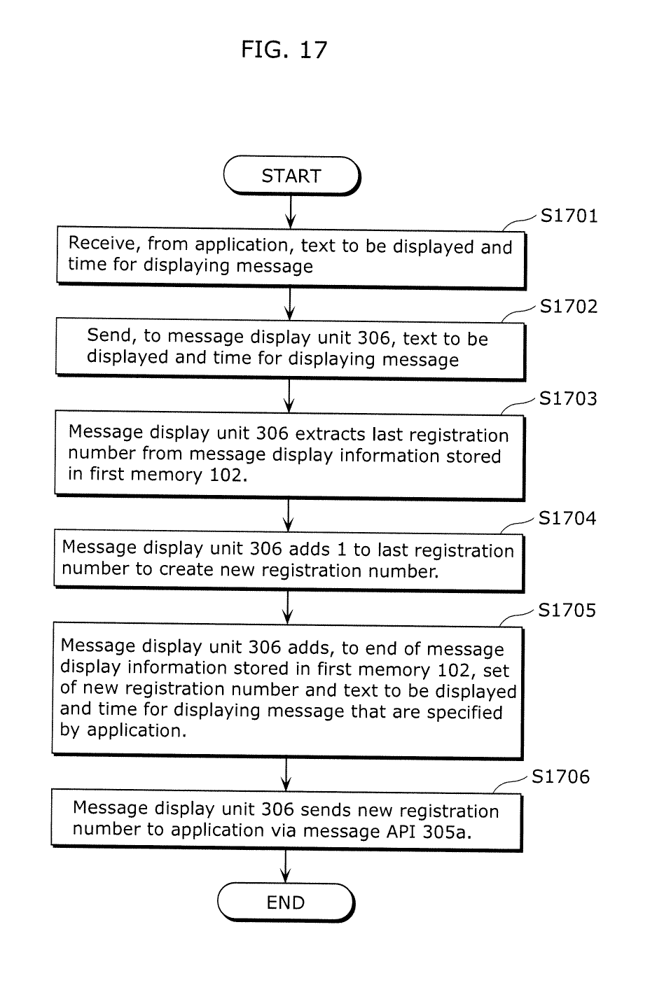

FIG. 17 is a flow chart showing operations of a registration API of the message API 305a. It is to be noted that the registration API is an API for registering a message, and has functions shown by, for instance, the function 601 shown by FIG. 6. The message API 305a receives, from an application, a text (message) to be displayed and a time for displaying the message (a display start time) (step S1701). Next, the message API 305a sends, to the message display unit 306, the text to be displayed and the time for displaying the message (step S1702). The message display unit 306 extracts the last registration number from message display information stored in the first memory 102 (step S1703). The message display unit 306 adds 1 to the last registration number to create a new registration number (message identification information) (step S1704). The message display unit 306 adds a set including the new registration number, the text (message) to be displayed, which is specified by the application, and the time for displaying the message, to the end of the message display information stored in the first memory 102 (step S1705). In other words, the message display unit 306 registers, as one set, the new registration number, the text (message), and the time in association with each other, at the end of the message display information. The message display unit 306 sends the new registration number to the application via the message API 305a (step S1706).

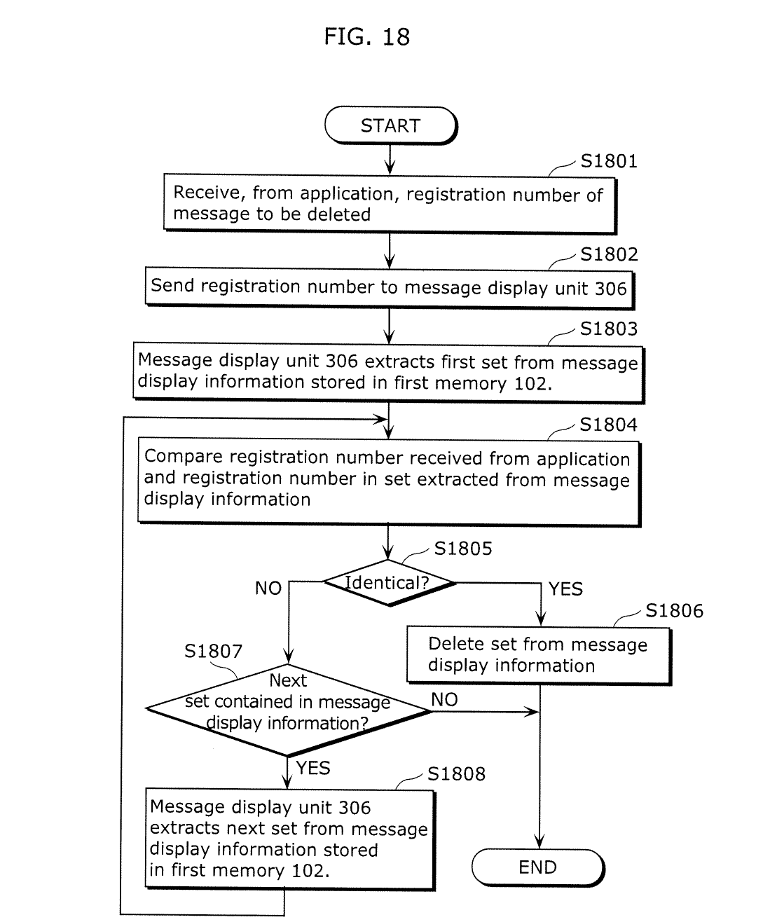

FIG. 18 is a flow chart showing operations of a deletion API of the message API 305a. It is to be noted that the deletion API is an API for deleting a registered message, and has functions shown by, for example, the function 602 shown by FIG. 6. The message API 305a receives, from an application, a registration number (message identification information) of a message to be deleted (step S1801). The message API 305a sends the received registration number to the message display unit 306 (step S1802). The message display unit 306 extracts the first set from message display information stored in the first memory 102 (step S1803). The message display unit 306 compares the registration number received from the application and a registration number in the set extracted from the message display information (step S1804). Then, the message display unit 306 determines whether or not the registration numbers are identical to each other (step S1805). When determining that the registration numbers are identical to each other (“YES” in step S1805), the message display unit 306 deletes a set corresponding to the registration number received from the application, from the message display information in the first memory 102, and ends the processing (step S1806). In contrast, when determining that the registration numbers are not identical to each other (“NO” in step S1805), the message display unit 306 determines whether or not the next set is contained in the message display information (step S1807). Here, when determining that the next set is not contained (“NO” in step S1807), the message display unit 306 ends the processing. In contrast, when determining that the next set is contained (“YES” in step S1807), the message display unit 306 extracts the next set from the message display information stored in the first memory 102 (step S1808), and advances the processing to step S1804.

As described above, in this embodiment, since the message API 305a is provided from the application library 305, an application executed by the application engine 304, such as a health management app, makes it possible to store, in the first memory 102 in advance, message display information that indicates a message specified by the application and a time (display start time) in association with each other, using the message API 305a. To put it differently, the message display unit 306 receives the message and the time from the application via the message API 305a, and registers the message and the time in the message display information stored in the first memory 102. In addition, the message display unit 306 requests the OS library 301b to call the message display unit 306 at the time received from the application via the message API 305a. With this, the OS library 301b calls the message display unit 306 at the time as requested. Then, the called message display unit 306 selects, from among messages registered in the message display information stored in the first memory 102, a message associated with a time corresponding to the current time indicated by the clock 108, and displays the message on the monitor 107.

Moreover, the television receiver according to this embodiment can be said to be the following device. Stated differently, the television receiver according to this embodiment is a television receiver that presents a message, the television receiver including: a receiving unit that receives broadcast waves; a reproduction unit that reproduces video and audio from the broadcast waves received by the receiving unit; a video display unit that displays the video reproduced by the reproduction unit; an audio output unit that outputs the audio reproduced by the reproduction unit; an application execution unit that reads and executes a first application program; a message information registration unit that receives a message and a display start time from the first application program executed by the application execution unit, and registers the message and the display start time; and a message display unit that displays the message registered by the message information registration unit at the display start time registered by the message information registration unit.

Here, the television receiver, the receiving unit, the reproduction unit, the video display unit, the audio output unit, and the application execution unit are the television, the receiving unit 104, the reproduction unit 105, the monitor 107, the speaker 106, and the application engine 304, respectively. Moreover, the message information registration unit includes functions of the message API 305a and the message display unit 306. Furthermore, the message display unit includes functions of the message display unit 306.

The execution of the first application program leads to the registration of the message and the display start time, and the message is displayed at the display start time. Thus, even when the application execution unit is not activated, that is, the first application program is not executed, it is possible to display the registered message at the display start time. Consequently, in the case where the first application program is scheduled to display the message at the display start time, as long as the first application program registers in advance the message and the display start time, the first application program makes it possible to display the message at the display start time regardless of a state of the television receiver at the display start time.

Moreover, the message information registration unit includes: an accepting unit that accepts the message and the display start time; a registration unit that assigns message identification information to the accepted message and display start time, and registers a set including the message identification information, the message, and the display start time, in the message registration information; and a sending unit that sends the message identification information assigned to the message and the display start time, to the first application program. Here, the accepting unit and the sending unit each include the functions of the message API 305a, and the registration unit includes the functions of the message display unit 306.

Furthermore, the television receiver further includes: a message identification information accepting unit that accepts, from the first application program executed by the application execution unit, message identification information; and a deleting unit that deletes, from the message registration information, a set including message identification information identical to the message identification information accepted by the message identification information accepting unit. Here, the message identification information accepting unit includes the functions of the message API 305a, and the deleting unit includes the functions of the message display unit 306.

### Embodiment 2

The following describes a television with a message display function (television receiver) according to Embodiment 2 of the present invention, with reference to the drawings. The television with the message display function according to this embodiment has the same hardware configuration as the television 100 with the message display function according to Embodiment 1 (FIG. 1). The television according to this embodiment differs from the television 100 according to Embodiment 1 in a configuration of a program stored in the first memory 102 and executed by the CPU 111.

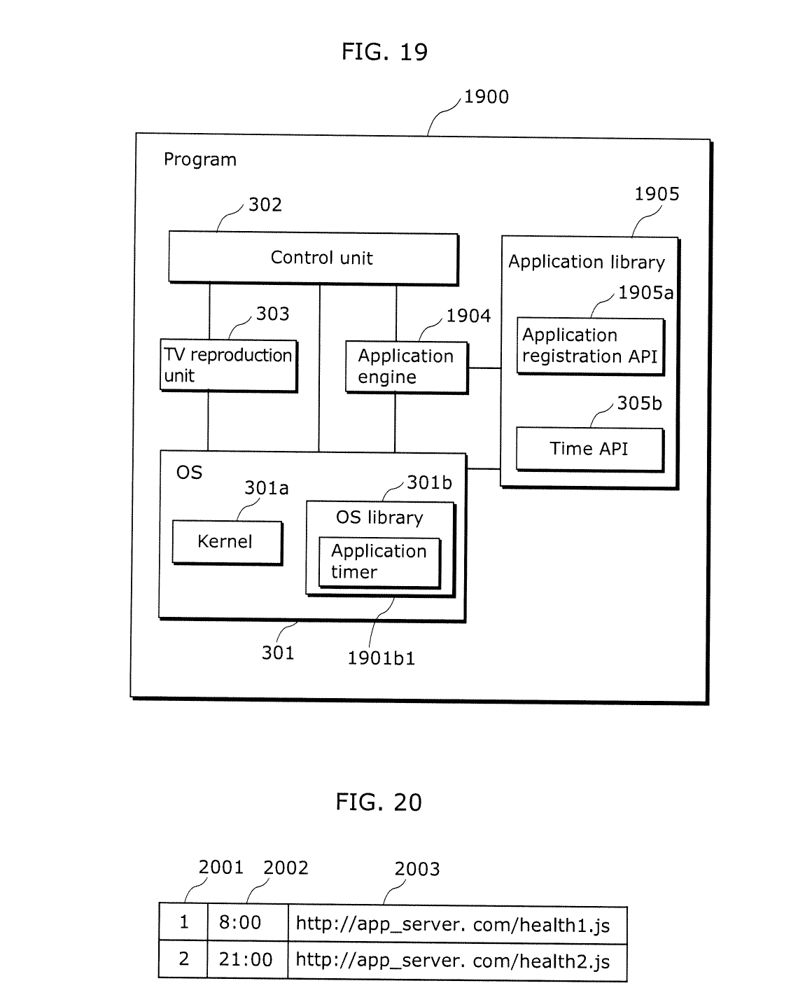

FIG. 19 is a block diagram showing an exemplary configuration of a program stored in the first memory 102 and executed by the CPU 111. A program 1900 includes a plurality of subprograms. Specifically, the program 1900 includes an OS 301, a control unit 302, a TV reproduction unit 303, an application engine 1904, and an application library 1905. It is to be noted that the same reference signs as those of the constituent elements of the television 100 according to Embodiment 1 are assigned to, among constituent elements of the television according to this embodiment, the same constituent elements as those of the television 100, and descriptions thereof are omitted.

An application timer 1901b1 exists as part of the OS library 301b. The application timer 1901b1 accepts, from the application engine 1904, an instruction to activate the application engine 1904 at a specific time (activation time). As a result, when the current time indicated by the clock 108 reaches the specific time (activation time), the application timer 1901b1 activates the application engine 1904.

The application engine 1904 executes an application indicated by activation file information (activation program information) registered by an application registration API 1905a in the application library 1905, in addition to functions of the application engine 304 according to Embodiment 1. The application registration API 1905a receives a set including an activation time and information indicating an application to be activated that are specified or notified by an application, and transfers the set to the application engine 1904.

The application engine 1904 adds the set to the end of application registration information stored in the first memory 102, to register the set in the application registration information.

FIG. 20 is a diagram showing exemplary application registration information stored in the first memory 102. The application registration information has a column 2001 in which an application information number (application identification information) assigned to an activation time and an application (activation file information) is registered. The application registration information has a column 2002 and a column 2003 in which an activation time that is a time for activating an application (the application engine 1904) and activation file information indicating an application to be activated are registered, respectively. Here, an example is described where two applications (activation file information) are registered in application registration information, with reference to FIG. 20.

The application engine 1904 requests the application timer 1901b1 in the OS library 301b to call the application engine 1904 at 8:00 and 21:00, based on the application registration information. The OS library 301b calls (activates), by reference to the clock 108, the application engine at 8:00 and 21:00. The called application engine 1904 activates (executes), by reference to the application registration information stored in the first memory 102, an application indicated by activation file information in the same set as an activation time corresponding to the current time indicated by the clock 108. For example, when called at 8:00, the application engine 1904 compares the time indicated by the clock 108 and an activation time in the application registration information stored in the first memory 102, and specifies activation file information indicating an application to be activated. In the case where the application engine 1904 is called at 8:00, the application engine 1904 successfully specifies, as an application to be activated, an application indicated by activation file information corresponding to the application information number “1” and the activation time “8:00.” Thus, the application having the application information number “1” is activated.

The application library 1905 provides, to a downloaded application, various APIs for using functions of the television. In the case where the application is a Java (registered trademark) program, the application library 1905 is a Java (registered trademark) class library, and in the case where the application is a Java (registered trademark) script program, the application library 1905 is a Java (registered trademark) script library.

The application library 1905 includes a plurality of libraries. In this embodiment, the application library 1905 includes the application registration API 1905a and the time API 305b.

The application registration API 1905a functions to register an application (activation file information) that is specified by the application and activated at an activation time, and to delete an application (activation file information) that is specified by the application and activated at a registered activation time.

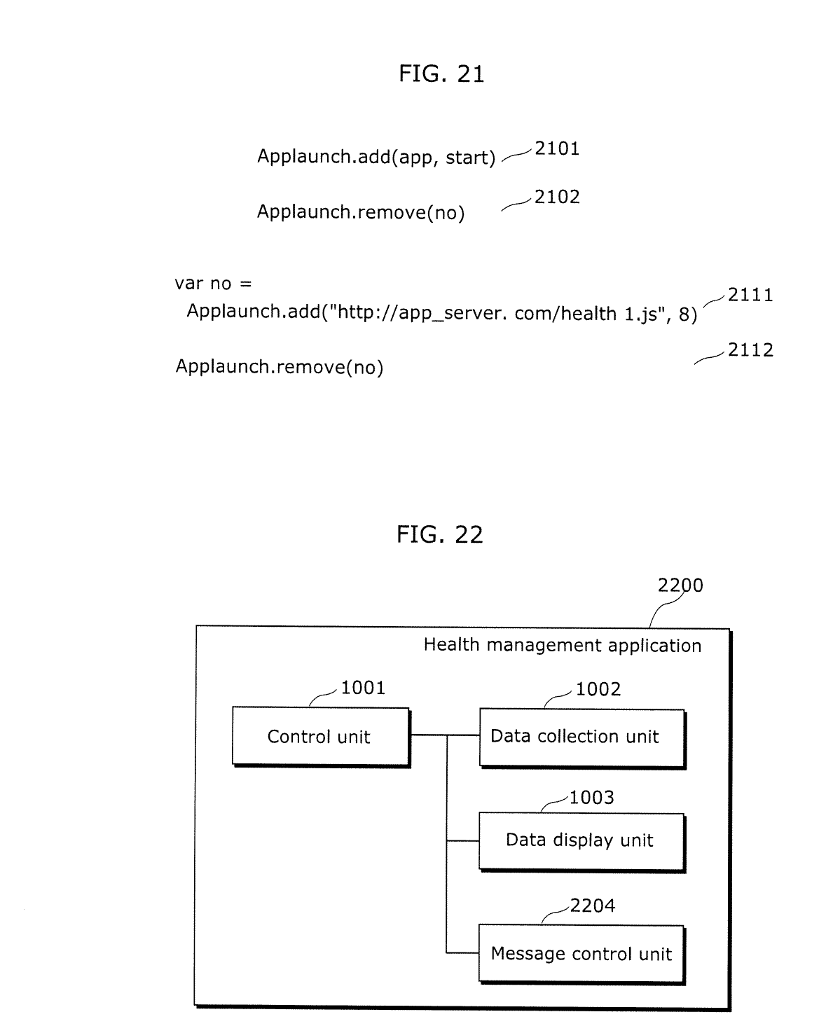

FIG. 21 is a diagram showing a specific example of the application registration API 1905a. The application registration API 1905a includes the function 2101 “Applaunch.add” and the function 2102 “Applaunch.remove.” The function 2101 “Applaunch.add” is an API that registers activation file information and an activation time of an application to be activated, in application registration information. In the function 2101, the first argument “app” indicates an activation file information of an application to be activated, and the second argument “start” indicates a start activation time. The function 2101 returns an application information number (application identification information) as a return value.

The function 2102 “Applaunch.remove” is an API that deletes activation file information of an application to be activated at a registered activation time. The application information number returned by the function 2101 is assigned to the first argument “no” of the function 2102.

Functions 2111 and 2112 are usage examples of the functions 2101 and 2102. The function 2111 specifies the activation file information of an application to be executed “htt://app_server.com/health1.js” and the activation time “8” o'clock, and stores an application information number that is a return value of the function, in the variable “no.” In the function 2112, the application information number stored in the variable “no” is transferred to the argument of the function 2102. The function 2112 deletes, from the application registration information, the activation time and the activation file information of the application to be executed at the activation time that are registered by the function 2111.

The application registration API 1905a makes it possible to register sets each including an activation time and activation file information of an application to be activated at the activation time. The function 2101 “Applaunch.add” returns application information numbers so as to identify the registered sets. It is possible to uniquely specify one set, that is, an application to be activated at a specific activation time, using a corresponding one of the application information numbers.

Information registered or deleted by the application registration API 1905a is sent to the application engine 1904.

An example of two registered applications (activation file information) is described with reference to FIG. 20. An application indicated by the activation file information “http://app_server.com/health1.js” is an application that displays the message “Please measure body weight.” for three minutes. Specifically, the application displays the message as shown by, for instance, FIG. 9. The display time may be changed to four minutes, five minutes, or the like.

An application indicated by the activation file information “http://app_server.com/health2.js” is an application that transfers data from a measurement apparatus to a television, and has functions of the data collection unit 1002 of the health management app described in Embodiment 1. When activated, as shown by FIG. 13, the application first displays, on the monitor 107, a data transfer instruction screen for urging the user to transfer data. The user connects, for example, the measurement apparatus and the USB connector 109 of the television with a USB cable, and notifies the application through the input unit 101 that the data transfer is ready. When receiving, from the user through the input unit 101 and the application library 1905, the notification that the data transfer is ready, as shown by FIG. 14, the application displays, on the monitor 107, a data transfer state screen that shows a message indicating data being transferred and a proportion (percentage) of data transferred. The application receives measurement data from the measurement apparatus through the USB connector 109, and records the measurement data in a management file in the first memory 102. The management file (measurement data) can be used by the health management app described in Embodiment 1.

The following describes a health management app as an exemplary application executed by the television with the message display function in this embodiment.

FIG. 22 is a block diagram showing a configuration of a health management app. A health management app 2200 includes the control unit 1001 that is a subprogram, the data collection unit 1002, the data display unit 1003, and a message control unit 2204. It is to be noted that the same reference signs as those of the constituent elements of the health management app 1000 according to Embodiment 1 are assigned to, among constituent elements of the health management app 2200 according to this embodiment, the same constituent elements as those of the health management app 1000, and descriptions thereof are omitted.

The message control unit 2204 displays, using the application library 1905, a message setting screen as shown by FIG. 11 on the monitor 107, to urge the user to set a message. In the exemplary message setting screen shown by FIG. 11, it is possible to set times (a “measurement time 1” and a “measurement time 2”) each for displaying a message urging daily body weight measurement, and a time for displaying a message urging data transfer. It is also possible to set display or non-display of a message. In FIG. 11, display of a message urging first body weight measurement at a measurement time is set ON, and the measurement time is set to “8:00.” Display of a message urging second body weight measurement at a measurement time is set OFF. Display of a message urging data transfer is set ON, and a display time of the message is set to “21:00.” The user can change the set information through the input unit 101, and determine the settings. When the settings are determined, the message control unit 2204 registers, using the message API 1905a provided by the application library 305, a set including an application information number, activation file information indicating an application to be executed, and an activation time, in application registration information, according to the determined information. Specifically, in the case of FIG. 11, the message control unit 2204 sends, to the application engine 1904, activation file information items and activation times respectively corresponding to two applications, by calling the function 2101 “Applaunch.add” two times. The application engine 1904 assigns, for each of the applications, an application information number to the sent activation file information and activation time, and registers (adds) a set including the application information number, the activation file information, and the activation time, in the application registration information stored in the first memory 102. FIG. 20 shows the application registration information stored in the first memory 102.

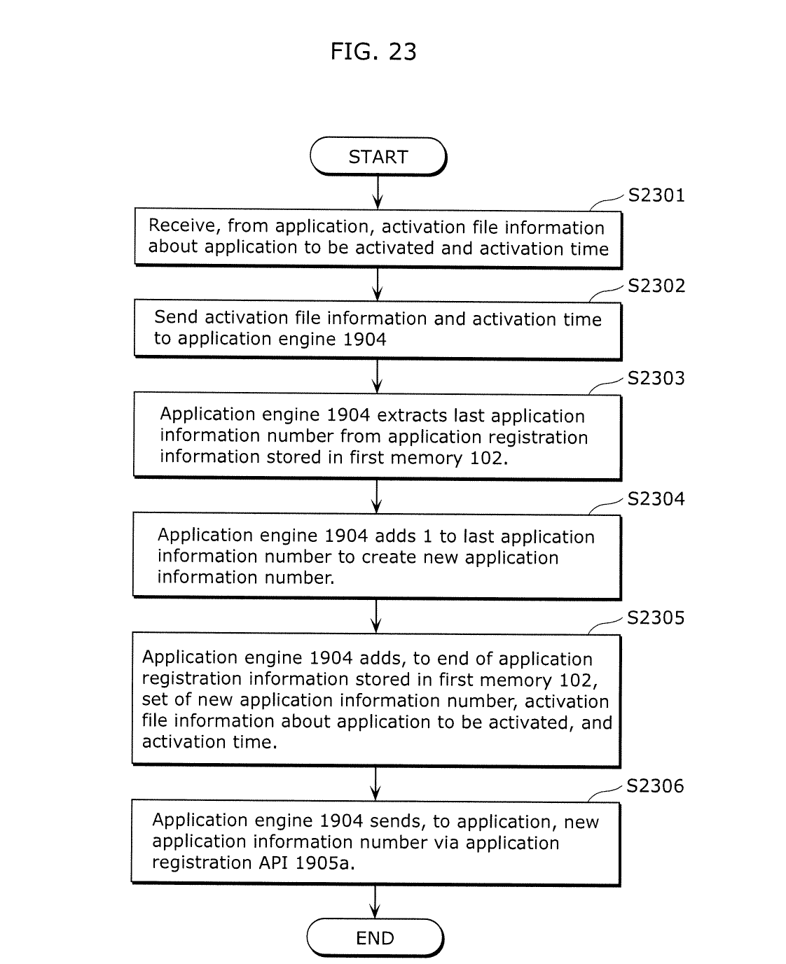

FIG. 23 is a flow chart showing operations of a registration API of the application registration API 1905a. It is to be noted that the registration API is an API for registering a message, and has functions shown by, for instance, the function 2101 shown by FIG. 21. The application registration API 1905a receives, from an application to be activated, activation file information and an activation time of the application (step S2301). Next, the application registration API 1905a sends the received activation file information and activation time to the application engine 1904 (step S2302). The application engine 1904 extracts the last application information number from application registration information stored in the first memory 102 (step S2303). The application engine 1904 adds 1 to the last application information number to create a new application information number (application identification information) (step S2304). The application engine 1904 adds, to the end of the application registration information stored in the first memory 102, a set including the new application information number, the activation file information indicating the application to be activated, and the activation time (step S2305). In other words, the application engine 1904 registers, as one set, the new application information number, the activation file information, and the activation time in association with each other, at the end of the application registration information. The application engine 1904 sends the new application information number to the application via the application registration API 1905a (step S2306).

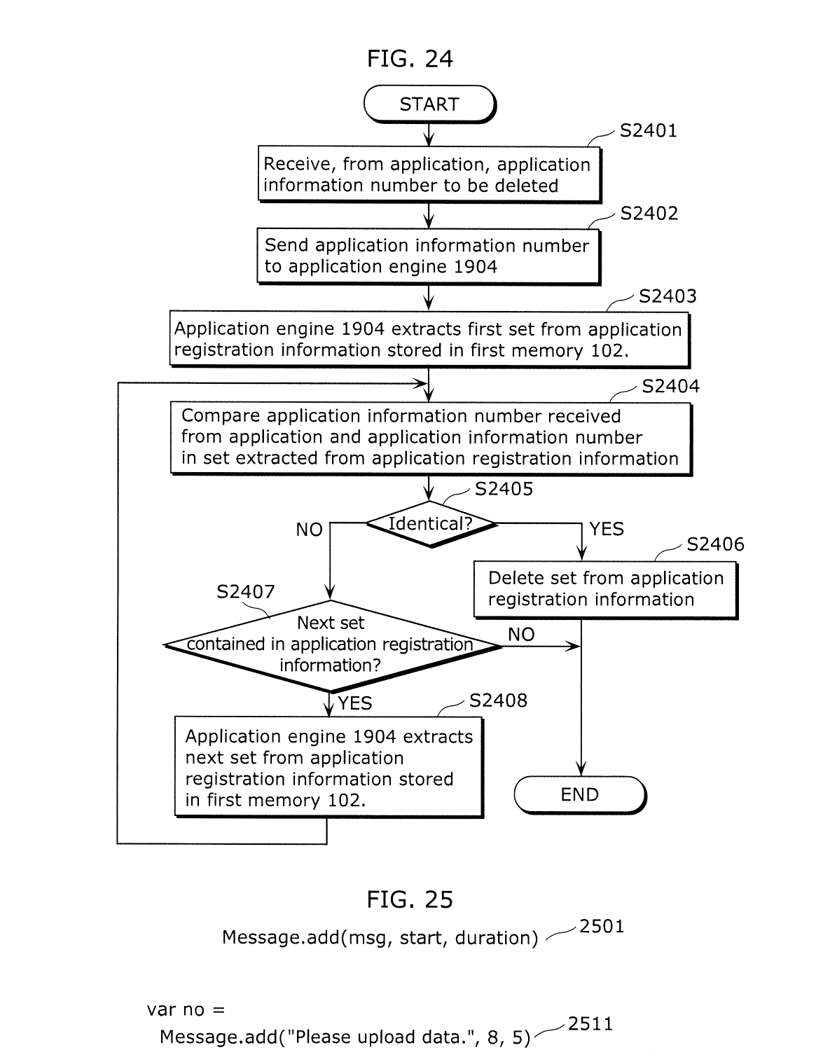

FIG. 24 is a flow chart showing operations of a deletion API of the application registration API 1905a. It is to be noted that the deletion API is an API for deleting a registered message, and has functions shown by, for example, the function 2102 shown by FIG. 21. The application registration API 1905a receives, from an application, an application information number to be deleted (application identification information) (step S2401). The application registration API 1905a sends the received application information number to the application engine 1904 (step S2402). The application engine 1904 extracts the first set from application registration information stored in the first memory 102 (step S2403). The application engine 1904 compares the application information number received from the application and an application information number included in the set extracted from the application registration information (step S2404). Then, the application engine 1904 determines whether or not the application information numbers are identical to each other (step S2405). When determining that the application information numbers are identical to each other (“YES” in step S2405), the application engine 1904 deletes, from the application registration information stored in the first memory 102, a set corresponding to the application information number received from the application (step S2406), and ends the processing. In contrast, when determining that the application information numbers are not identical to each other (“NO” in step S2405), the application engine 1904 determines whether or not the next set is contained in the application registration information (step S2407). Here, when determining that the next set is not contained (“NO” in step S2407), the application engine 1904 ends the processing. In contrast, when determining that the next set is contained (“YES” in step S2407), the application engine 1904 extracts the next set from the application registration information stored in the first memory 102 (step S2408), and advances the processing to step S2404.

As described above, in this embodiment, since the application registration API 1905a is provided from the application library 1905, an application executed by the application engine 1904, such as a health management app, makes it possible to store, in the first memory 102 in advance, message registration information that indicates activation file information specified by the application and an activation time in association with each other, using the application registration API 1905a. Stated differently, the application engine 1904 receives, from the application, the activation file information and the activation time via the application registration API 1905a, and registers the activation file information and the activation time in application registration information stored in the first memory 102. In addition, the application engine 1904 requests the application timer 1901b1 of the OS library 301b to call the application engine 1904 at the activation time received from the application via the application registration API 1905a. As a result, the application timer 1901b1 of the OS library 301b calls (activates) the application engine 1904 at the activation time as requested. Then, the called application engine 1904 selects, from among activation file information items registered in the application registration information stored in the first memory 102, activation file information associated with an activation time corresponding to the current time indicated by the clock 108, and executes an application indicated by the selected activation file information. It is to be noted that the application indicated by the activation file information may be an application (e.g., the health management app) that has registered the activation file information using the application registration API 1905a, or another application. As stated, the application executed (at the activation time) displays, for example, the message “Please measure body weight.” on the monitor 107.

Moreover, the television receiver according to this embodiment can be said to be the following device. In other words, the television receiver according to this embodiment is a television receiver that presents a message, the television receiver including: a receiving unit that receives broadcast waves; a reproduction unit that reproduces video and audio from the broadcast waves received by the receiving unit; a video display unit that displays the video reproduced by the reproduction unit; an audio output unit that outputs the audio reproduced by the reproduction unit; an application execution unit that reads and executes a first application program; an application information registration unit that accepts activation program information and an activation time from the first application program executed by the application execution unit, and registers the activation program information and the activation time; and an activation control unit that activates the application execution unit at the activation time registered by the application information registration unit, wherein in response to an activation instruction from the activation control unit, the application execution unit executes a second application program that presents the message and is indicated by the activation program information registered by the application information registration unit.

Here, the television receiver, the receiving unit, the reproduction unit, the video display unit, the audio output unit, and the application execution unit are the television, the receiving unit 104, the reproduction unit 105, the monitor 107, the speaker 106, and the application engine 1904, respectively. Moreover, the application information registration unit includes functions of the application engine 1904 and the application registration API 1905a. Furthermore, the activation control unit is the application timer 1901b1.

The execution of the first application program leads to the registration of the activation program information and the activation time, and the activation control unit activates the application execution unit at the activation time. Thus, even when the application execution unit is not activated, that is, the second application program is not executed, it is possible to activate the application execution unit at the activation time to execute the second application program indicated by the registered activation program information. As a result, in the case where the second application program is scheduled to make it possible to present a message at the activation time, as long as the first application program registers in advance the activation time and the activation program information indicating the second application program, the second application program makes it possible to present the message at the activation time regardless of a state of the television receiver at the activation time. Furthermore, the message is not set by the user or preset but is specified by the second application program, and thus it is possible to increase a degree of flexibility in display contents and a display state of the message.

Moreover, the application information registration unit includes: an accepting unit that accepts activation program information and an activation time; a registration unit that assigns application identification information to the accepted activation program information and activation time, and registers a set including the application identification information, the activation program information, and the activation time, in application registration information; and a sending unit that sends, to the first application program, the application identification information assigned to the activation program information and the activation time. Here, the accepting unit and the sending unit include the functions of the application registration API 1905a, and the registration unit includes the functions of the application engine 1904.

The television receiver further includes: an application identification information accepting unit that accepts application identification information from the first application program executed by the application execution unit; and a deleting unit that deletes, from the application registration information, a set including application identification information identical to the application identification information accepted by the application identification information accepting unit. Here, the application identification information accepting unit includes the functions of the application registration API 1905a, and the deleting unit includes the functions of the application engine 1904.

### Embodiment 3

In Embodiment 3 of the present invention, the following functions are added to, or modifications are made to, the message API 305a and the message display unit 306 described in Embodiment 1.

(1) Specification of Message Display Time Period

It is not possible to specify a message display time period in Embodiment 1. A television in this embodiment allows an application to specify a message display time period and display a message for the message display time period.

FIG. 25 is a diagram showing a specific example where specification of a message display time period is added to the message API 305a. The message API 305a includes a function 2501 instead of the function 601 described in Embodiment 1. The function 2501 “Message.add” is an API that registers a text (message) to be displayed and a time for displaying the message. In the function 2501, the first argument “msg,” the second argument “start,” and the third argument “duration” indicate a text, a time for displaying a message, and a message display time period, respectively.

A function 2511 is a usage example of the function 2501. The function 2511 specifies the text to be displayed “Please upload data,” the time “8” o'clock at which the message is displayed, and the message display time period “5” minutes, and stores a registration number, a return value of the function 2511, in the variable “no.” The message API 305a transfers a text to be display, a time for displaying the message, and a message display time period to the message display unit 306.

When the specification of the message display time period is added to the message API 305a, the message display unit 306 adds, to the message display information stored in the first memory 102, a set including the message display time period.

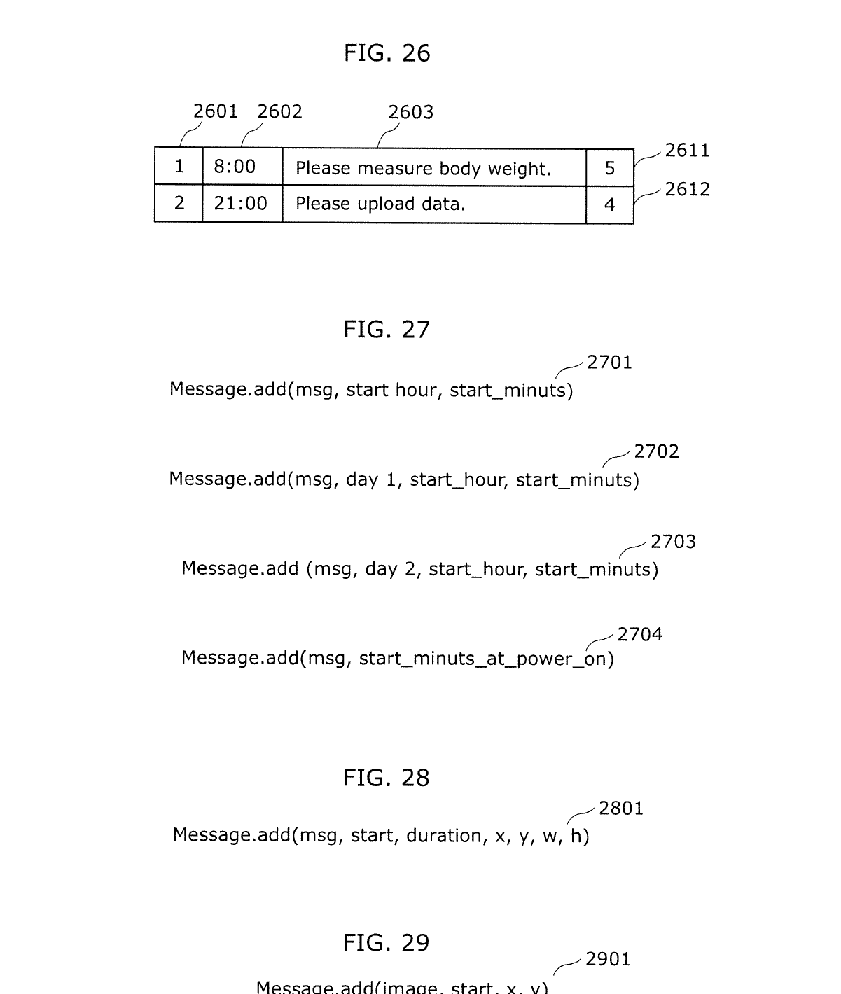

FIG. 26 is a diagram showing exemplary message display information stored in the first memory 102. The message display information has a column 2601 in which registration number of a message is registered. The message display information has a column 2602, a column 2603, and a column 2604 in which a time for displaying a message, a text (message) to be displayed, and a message display time period are registered, respectively. The message display information has a row 2611 in which a set including the registration number “1,” the time for displaying a message “8:00,” the message to be displayed “Please measure body weight,” and the message display time period “5” minutes is registered. The message display information has a row 2612 in which a set including the registration number “2,” the time for displaying a message “21:00,” the message to be displayed “Please upload data,” and the message display time period “4” minutes is registered.

The message display unit 306 displays a message on the monitor 107 based on the message display information, as in Embodiment 1. Here, a display time period is in conformity with a message display time period in the message display information stored in the first memory 102. To put it differently, when displaying a message registered in the message display information stored in the first memory 102, the message display unit 306 displays the message on the monitor 107 for a message display time period in a set (row) to which the message belongs.

(2) Representation Modification of Message Display Start Time

It is possible to specify a message display start time only on an hourly basis in Embodiment 1. The television in this embodiment allows an application to specify a message display start time on an hourly basis and a minute basis, and to further specify a day of the week or a date for displaying a message.

FIG. 27 is a diagram showing a specific example where the message API 305a is modified. The message API 305a includes one of functions 2701 to 2704 instead of the function 601 described in Embodiment 1. A minute is added as the third argument “start_minuts” to be specified, to the function 2701. A day of the week and a minute are added as the second argument “day 1” and the fourth argument “start_minuts” that are to be specified, to the function 2702. A date and a minute are added as the second argument “day 2” and the fourth argument “start_minuts” that are to be specified, to the function 2703. It is to be noted that the argument “start_hour” corresponds to the argument “start” in Embodiment 1.

When the specification of the above minute, day of the week, or date is added to the message API 305a, the message display unit 306 adds, to the message display information stored in the first memory 102, a set including information about the specified minute or the like, in the same manner as in “(1) Specification of message display time period.” Furthermore, the message display unit 306 displays the message on the monitor 107 at the specified minute, on the specified day of the week, or on the specified date, based on the message display information.

Alternatively, the application makes it possible to specify a time from when the television is powered on to when a message is displayed (a time period after power-on). It is to be noted that the time period after power-on is a time that has passed since the television was powered on. In the function 2704, a message to be displayed is specified as the first argument “msg,” and a time period after power-on, that is, the number of minutes from when the television is powered on to when the message is displayed is specified as the second argument “start_minuts_at_power_on.” In the case where the number of minutes is specified to 0, the television displays the message immediately after being powered on. Moreover, when the time period after power-on is specified by the function 2704, the message display unit 306 adds, to the message display information stored in the first memory 102, a set including the time period after power-on. Furthermore, the message display unit 306 requests the OS library 301b to call (activate) the message display unit 306 based on the time period after power-on. Thus, the OS library 301b activates the message display unit 306 when the time period after power-on has passed since the television was powered on. As a result, the message display unit 306 makes it possible to display the specified message on the monitor 107 when the time period after power-on has passed.

It is to be noted that at least one of the above arguments “start_minuts,” “start_minuts_at_power_on,” “day 1,” and “day 2” may be added to the function 2101 “Applaunch.add (app, start)” in Embodiment 2 as well.

(3) Specification of Message Display Position

It is not possible to specify a display position and a display size of a message in Embodiment 1. The television in this embodiment allows an application to specify a display position and a display size of a message, and display the message in the display size and at the display position.

FIG. 28 is a diagram showing a specific example where specification of a display position and a display size of a message is added to the message API 305a. The message API 305a includes a function 2801 instead of the function 601 described in Embodiment 1. The function 2801 “Message.add” is an API that registers a text to be displayed, a time for displaying the message, a message display time period, and a display position and a display size of the message. Specifically, in the function 2801, the first argument “msg,” the second argument “start,” the third argument “duration,” the fourth argument “x,” the fifth argument “y,” the sixth argument “w,” and the seventh argument “h” indicate a text to be displayed, a time for displaying the message, a message display time period, an upper left x coordinate of a display position of the message, an upper left y coordinate of the display position of the message, a width of a display size of the message, and a height of the display size of the message, respectively.

When the specification of the above display position and display size is added to the message API 305a, the message display unit 306 adds, to the message display information stored in the first memory 102, a set including information about the specified display position or the like, in the same manner as in “(1) Specification of message display time period.” Furthermore, the message display unit 306 displays the message in the specified display size and at the specified display position, based on the message display information.

(4) Specification of Image Data in Displaying Message

An application specifies a text to be displayed as a message in Embodiment 1, whereas an application makes it possible to specify an image (image data) as a message instead of the text in this embodiment.

FIG. 29 is a diagram showing a specific example of the message API 305a that makes it possible to specify an image to be displayed as a message. The message API 305a includes a function 2901 instead of the function 601 described in Embodiment 1. The function 2901 “Message.add” is an API that registers image information indicating an image to be displayed, a time for displaying the message, and a display position of the image. In the function 2901, the first argument “image,” the second argument “start,” the third argument “x,” and the fourth argument “y” indicate image information, a time for displaying a message, an upper left x coordinate of a display position of an image, and an upper left y coordinate of the display position of the image, respectively. Examples of the image information include a file name of an image or a pointer of a memory in which an image is stored. A Java (registered trademark) application makes it possible to transfer an Image Class object to the argument.

When the above image information or the like is specified in the message API 305a, the message display unit 306 adds, to the message display information stored in the first memory 102, a set including the specified image information, in the same manner as in “(1) Specification of message display time period.” Furthermore, the message display unit 306 displays the image (message) indicated by the specified image information, at the specified display position, based on the message display information.

### Embodiment 4

In Embodiment 4 of the present invention, the following functions are added to the health management application described in Embodiment 2.

(1) Display Date of Previous Data Transfer

An application indicated by the activation file information “http://app_server.com/health2.js” is an application that transfers data from a measurement apparatus to the television 100, and has functions of the data collection unit 1002 of the health management app described in Embodiment 1. When activated, the application reads a management file stored in the first memory 102 to extract a date of the last recorded data. For instance, in the case where the management file is in the state as shown by FIG. 15, a date of data last recorded in the management file is June 28 (6/28). Thus, “June 28” is extracted as the date of the data last recorded in the management file. Next, the application searches a current date, using the time API 305b. The application calculates a difference between the two dates (the date of the data last recorded in the management file and the current date). Here, assuming that the application is activated on June 30, the difference is two days. Subsequently, in the case where, for example, the difference is greater than a threshold value, the application displays, on the monitor 107, a message for urging the user to transfer data and the date of the previous data transfer “June 28.” Moreover, the application may display a period for which data has not been transferred instead of the date of the previous data transfer.

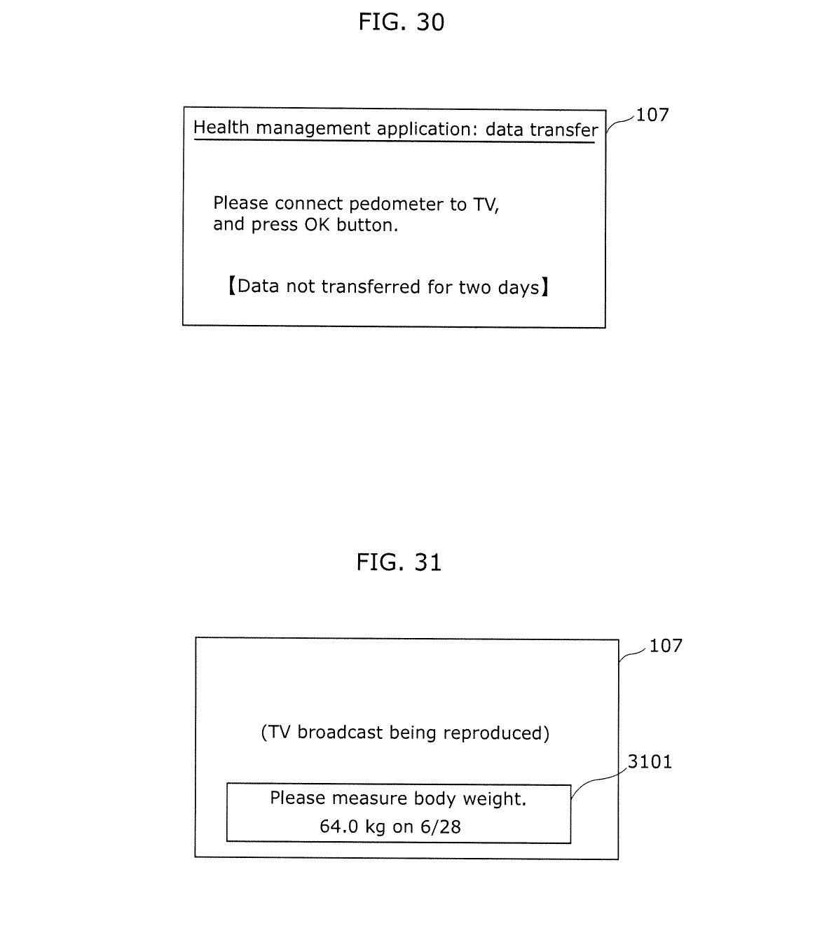

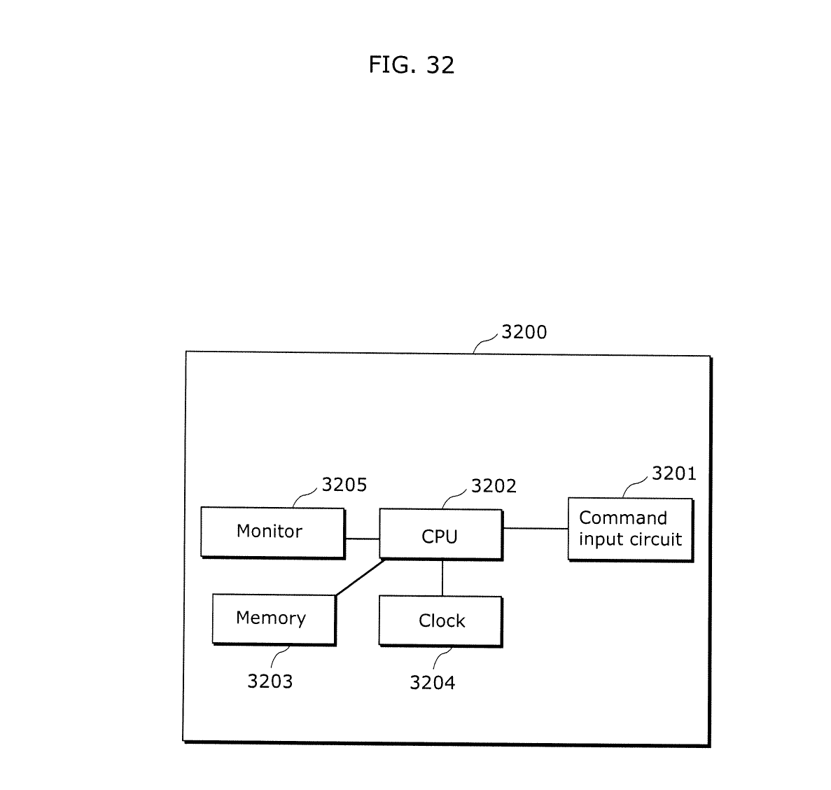

FIG. 30 is a diagram showing a screen of the monitor 107 on which a period for which data has not been transferred is displayed. For instance, on the screen, “Please connect pedometer to TV, and press OK button.” is displayed as a message for urging the user to transfer data, and “Data not transferred for two days” is displayed as a message for notifying a period for which data has not been transferred.

(2) Display of Previous Measurement Value (Measurement Data)

When activated, an application indicated by the activation file information “http://app_server.com/health1.js” reads a management file stored in the first memory 102 to extract a date of data last recorded and a measurement value or measurement data (e.g., body weight). Then, the application displays the extracted date and body weight on the monitor 107.

FIG. 31 is a diagram showing a screen of the monitor 107 on which a date and a body weight that are last recorded. For example, in the case where the management file is in the state as shown by FIG. 15, a date of measurement data last recorded is “June 28,” and a body weight is “64.0 kg.” Thus, in this case, as shown by FIG. 31, the application displays “64.0 kg on 6/28” together with the message “Please measure body weight.” for three minutes. The display time may be changed to four minutes, five minutes, or the like.

It is to be noted that although the present invention has been described based on Embodiments 1 to 4, the present invention is not certainly limited to the embodiments. The present invention includes the following cases.

(1) Although the application is downloaded by the network unit 110 (download unit) and stored into the second memory 103 in Embodiments 1 to 4, the application may be stored from a periphery device into the first memory 102 or the second memory 103 through the USB connector 109. Moreover, in the case where the television receiver includes a device that reads data from a recording medium such as a memory card, the television receiver may read an application stored in the recording medium through the device, and store the application into the first memory 102 or the second memory 103. Furthermore, in the case where an application is included in broadcast waves, the receiving unit 104 may extract the application from the broadcast waves, and store the application into the first memory 102 or the second memory 103.

(2) Although when the message is presented to the user, the text or image indicating the contents of the message is displayed on the monitor 107 in Embodiments 1 to 4, audio indicating the contents of the message may be outputted from the speaker 106.

(3) The television receiver may specifically be a computer system including a microprocessor, a ROM, a RAM, a hard disk unit, a display unit, a keyboard, a mouse, and so on. A computer program is stored in the RAM or the hard disk unit. The television receiver achieves its function as a result of the micro processing unit operating according to the computer program. Here, the computer program is configured by combining operation codes each indicating an instruction to a computer so that predetermined functions are achieved.

(4) Part or all of the constituent elements included in the television receiver may be configured from one system LSI (Large Scale Integration). A system LSI is a super-multifunctional LSI manufactured with a plurality of components integrated on a single chip, and specifically is a computer system including a microprocessor, a ROM, a RAM, and so on. A computer program is stored in the RAM. The system LSI achieves its function as a result of the microprocessor operating according to the computer program.

(5) Part or all of the constituent elements included in the television receiver may be configured from an IC card detachable from the television receiver or a stand-alone module. The IC card or the module is a computer system including a microprocessor, a ROM, a RAM, and so on. The IC card or the module may include the super-multifunctional LSI. The IC card or the module achieves its function as a result of the microprocessor operating according to a computer program. The IC card or the module may be tamper resistant.

(6) The present invention may be realized as the method described above. Moreover, the present invention may be realized as a computer program causing a computer to perform these methods, or a digital signal including the computer program.

Furthermore, the present invention may be realized as the computer program or the digital signal recorded on a computer-readable recording medium such as a flexible disk, a hard disk, a CD-ROM, an MO, a DVD, a DVD-ROM, a DVD-RAM, a BD (Blu-ray Disc), and a semiconductor memory. In addition, the present invention may be realized as the digital signal recorded on these recording media.

Moreover, the present invention may e realized by transmitting the computer program or the digital signal via, for instance, an electric telecommunication line, a wireless or wired communication line, a network represented by the Internet, or data broad cast.

Furthermore, the present invention may be realized as a computer system including a microprocessor and a memory, wherein the memory stores the computer program and the microprocessor operates according to the computer program.

Moreover, another independent computer system may execute the computer program or the digital signal that is recorded on the recording medium and transmitted to a different independent computer system or that is transmitted via the network or the like to the different independent computer system.

(7) The present invention may be realized by combining Embodiments 1 to 4.

### INDUSTRIAL APPLICABILITY

A television with a message display function according to the present invention is mainly used as a digital television, but can be also applied to, for instance, a DVD/BD player and a cellular phone.

### REFERENCE SIGNS LIST

100 Television receiver (television)

101 Input unit

102 First memory

103 Second memory

104 Receiving unit

105 Reproduction unit

106 Speaker

107 Monitor

108 Clock

109 USB connector

110 Network unit

111 CPU

300, 1900 Program

301 OS

301a Kernel

301b OS library

302 Control unit

303 TV reproduction unit

304 Application engine

305, 1905 Application library

305a Message API

305b Time API

306 Message display unit

1901b1 Application timer

1904 Application engine

1905a Application registration API

1. A television receiver that presents a message, the television receiver comprising:
a receiving unit configured to receive broadcast waves;
a reproduction unit configured to reproduce video and audio from the broadcast waves received by the receiving unit;
a video display unit configured to display the video reproduced by the reproduction unit;
an audio output unit configured to output the audio reproduced by the reproduction unit;
an application execution unit configured to read and execute a first application program;
an application information registration unit configured to receive activation program information and an activation time from the first application program executed by the application execution unit, and register the activation program information and the activation time; and
an activation control unit configured to activate the application execution unit at the activation time registered by the application information registration unit,
wherein in response to an activation instruction from the activation control unit, the application execution unit is configured to execute a second application program that presents the message and is indicated by the activation program information registered by the application information registration unit.

2. The television receiver according to claim 1,
wherein the application information registration unit includes:
an accepting unit configured to accept the activation program information and the activation time;
a registration unit configured to assign application identification information to the accepted activation program information and activation time, and register a set including the application identification information, the activation program information, and the activation time, in application registration information; and
a sending unit configured to send the application identification information assigned to the activation program information and the activation time, to the first application program.

3. The television receiver according to claim 2,
wherein the application information registration unit is configured to provide an application program interface (API) to the first application program,
the accepting unit is configured to accept the activation program information and the activation time from the first application program via the API, and
the sending unit is configured to send the application identification information assigned by the registration unit, to the first application program via the API.

4. The television receiver according to claim 3,
wherein a plurality of sets each including application identification information, activation program information, and an activation time are registered in the application registration information, and
when activated by the activation control unit, the application execution unit is configured to determine, among the sets registered in the application registration information, a set including the activation time corresponding to a current time, and execute the second application program indicated by the activation program information included in the determined set.

5. The television receiver according to claim 4, further comprising:
an application identification information accepting unit configured to accept the application identification information from the first application program executed by the application execution unit; and
a deleting unit configured to delete, from the application registration information, a set including application identification information identical to the application identification information accepted by the application identification information accepting unit.

6. The television receiver according to claim 1, further comprising
a download unit configured to download at least one of the first and second application programs via a network.

7. The television receiver according to claim 1,
wherein the application information registration unit is configured to accept and register the activation time as a time that has passed since the television receiver was powered on, and
the activation control unit is configured to activate the application execution unit when the time registered by the application information registration unit has passed since the television receiver was powered on.

8. The television receiver according to claim 1,
wherein the application information registration unit is configured to register, as the second application program, the activation program information indicating the first application program.

9. The television receiver according to claim 1, further comprising:
a message information registration unit configured to accept a message and a display start time from the first application program executed by the application execution unit, and register the message and the display start time; and
a message display unit configured to display the message registered by the message information registration unit, at the display start time registered by the message information registration unit.

10. The television receiver according to claim 9,
wherein the message information registration unit includes:
an accepting unit configured to accept the message and the display start time;
a registration unit configured to assign message identification information to the accepted message and display start time, and register a set including the message identification information, the message, and the display start time, in message registration information; and
a sending unit configured to send the message identification information assigned to the message and the display start time, to the first application program.

11. The television receiver according to claim 10,
wherein the message information registration unit is configured to provide an application program interface (API) to the first application program,
the accepting unit is configured to accept the message and the display start time from the first application program via the API, and
the sending unit is configured to send the message identification information assigned by the registration unit, to the first application program via the API.

12. The television receiver according to claim 11,
wherein a plurality of sets each including message identification information, a message, and a display start time are registered in the message registration information, and
the message display unit is configured to determine, among the sets registered in the message registration information, a set including the display start time corresponding to a current time, and display the message included in the determined set.

13. The television receiver according to claim 12, further comprising:
a message identification information accepting unit configured to accept the message identification information from the first application program executed by the application execution unit; and
a deleting unit configured to delete, from the message registration information, a set including message identification information identical to the message identification information accepted by the message identification information accepting unit.

14. The television receiver according to claim 9,
wherein the message information registration unit is configured to accept and register the display start time as a time that has passed since the television receiver was powered on, and
the message display unit is configured to display the message registered by the message information registration unit, when the time registered by the message information registration unit has passed since the television receiver was powered on.

15. The television receiver according to claim 9,
wherein the message information registration unit is further configured to accept a display position of the message from the first application program executed by the application execution unit, and register the display position, and
the message display unit is configured to display the message registered by the message information registration unit, at the display position registered by the message information registration unit.

16. The television receiver according to claim 9,
wherein the message information registration unit is further configured to accept a display time period for the message from the first application program executed by the application execution unit, and register the display time period, and
the message display unit is configured to display the message registered by the message information registration unit, for the display time period registered by the message information registration unit.

17. The television receiver according to claim 9,
wherein the message information registration unit is further configured to accept the message represented as image data from the first application program executed by the application execution unit, and register the message, and
the message display unit is configured to display the message represented as the image data.

18. A method of presenting a message performed by a television receiver, the method comprising:
receiving broadcast waves;
reproducing video and audio from the broadcast waves received in the receiving;
displaying the video reproduced in the reproducing;
outputting the audio reproduced in the reproducing;
reading and executing a first application program, the reading and executing being performed by an application execution unit;
accepting activation program information and an activation time from the first application program executed in the reading and executing, and registering the activation program information and the activation time;
activating the application execution unit at the activation time registered in the accepting and registering; and
executing a second application program that is indicated by the activation program information registered in the accepting and registering, and presents the message, the executing being performed by the application execution unit.

19. (canceled)

20. A computer-readable non-transitory recording medium having a computer program recorded thereon for causing a television receiver to present a message,
wherein the computer program includes:
receiving broadcast waves;
reproducing video and audio from the broadcast waves received in the receiving;
displaying the video reproduced in the reproducing;
outputting the audio reproduced in the reproducing;
reading and executing a first application program, the reading and executing being performed by an application execution unit;
accepting activation program information and an activation time from the first application program executed in the reading and executing, and registering the activation program information and the activation time;
activating the application execution unit at the activation time registered in the accepting and registering; and
executing a second application program that is indicated by the activation program information registered in the accepting and registering, and presents the message, the executing being performed by the application execution unit.
